(19) United States
(12) Patent Application Publication
(10) Pub. No.: US 2009/0292588 A1
(43) Pub. Date: Nov. 26, 2009

(54) METHODS AND SYSTEMS FOR THE DESIGN OF CHOICE EXPERIMENTS AND DEDUCTION OF HUMAN DECISION-MAKING HEURISTICS

(76) Inventors: Dejan Duzevik, Boston, MA (US); Jella Pfeiffer, Wollstein (DE); Eric Bonabeau, Winchester, MA (US)

Correspondence Address: FOLEY HOAG, LLP;PATENT GROUP, WORLD TRADE CENTER WEST, 155 SEAPORT BLVD, BOSTON, MA, 02110, US

(21) Appl. No.: 12/434,402

(22) Filed: May 1, 2009

Related U.S. Application Data
(60) Provisional application No. 61/126,106, filed on May 1, 2008.

(51) Int. Cl. G06Q 10/00; G06N 3/12

(52) U.S. Cl. 705/10; 706/13

(57) ABSTRACT

Methods, computer-readable media and systems are designed to apply genetic algorithms to design choice experiments for the purpose of studying decision-making processes and approaches. The methods, media and systems may be used to design the choice experiments, and also to evaluate how well various combinations of theories explain experimental results.

### REFERENCE TO RELATED APPLICATIONS AND CLAIM OF PRIORITY

The present application claims priority to the following provisional patent application, the entirety of which is expressly incorporated herein by reference: U.S. Ser. No. 61/126,106 filed on May 1, 2008.

### FIELD OF THE DISCLOSURE

The disclosed methods and systems relate generally to designing and interpreting choice experiments, and in particular to using genetic algorithms to facilitate such design and interpretation.

### BACKGROUND

A large body of research in the field of behavioral economics identifies and classifies a variety of human decision-making heuristics and biases. The empirical research in the field draws mainly on experimental analysis of people's behavior in the face of a predesigned choice environment.

These experiments require careful design. The complexity of the interacting independent variables and the importance of the experimental environment demand a sophisticated solution to the design of experiments problem. This disclosure describes an application of a genetic algorithm to design choice experiments. It goes on to apply similar techniques to analysis of results of such experiments.

### SUMMARY

In view of the foregoing, various embodiments of the present disclosure are directed to methods for designing choice experiments using genetic algorithms, and using these choice experiments. In particular, for use in a computer system comprising at least one input device, at least one output device, and at least one processor, a method of generating and using a set of choice experiments comprises: for each of a plurality of respondents, for a preselected product, for a predetermined number of product attributes, determining at least some of the said respondent's product attribute weights and product attribute utilities; for each of the plurality of respondents, based upon the determined product attribute weights and product attribute utilities, creating by means of a processor using a genetic algorithm a set of choice experiments; for each of the plurality of respondents, for each of a plurality of the set of created choice experiments associated with the said respondent, displaying by means of an output device the said choice experiment; for each of the plurality of respondents, for each of the plurality of the set of created choice experiments displayed, receiving by means of an input device a response to the choice experiment displayed; analyzing at least a plurality of the received responses to the choice experiments; and outputting by means of an output device at least one result of the analysis of the received responses.

At least one of the choice experiments created may comprise a comparison matrix presenting a predetermined number of product alternatives, each characterized by a predetermined number of product attributes. A purpose of the choice experiments may be to analyze respondent decision strategies. Determining at least some of the said respondent's product attribute weights and product attribute utilities may comprise use of adaptive conjoint analysis. Each of a plurality of the sets of choice experiments created may comprise a choice-based conjoint analysis. Creating a choice experiment may comprise determining a number of product alternatives to be presented, determining a number of product attributes to be presented for each product alternative presented, choosing product alternatives to be presented, and choosing product attributes to be presented. Creating a set of choice experiments may be based upon a preselected plurality of decision making strategies to be analyzed and an objective of the genetic algorithm may be to create choice experiments in which each choice maps to one and only one of the preselected plurality of decision making strategies to be analyzed. Each genotype analyzed by the genetic algorithm may comprise attribute level genes and attribute group genes. Analyzing at least a plurality of the received responses to the choice experiments may comprise use of statistical analysis and machine learning techniques. Operation of the genetic algorithm may include one of more of: a mutation operator and a crossover operator.

Other aspects of the present disclosure are computer-readable media having computer-readable signals stored thereon. The computer-readable signals define instructions which, as a result of being executed by a computer or computer system, instruct the computer or computer system to perform one or more of the methods disclosed herein. That is to say, the computer-readable medium has the said instructions stored therein.

Yet other aspects of the present disclosure are computers or computer systems having a user interface and at least one processor. The user interface includes a display or other output device and a selection device or other input device. The computers or computer systems may include or may facilitate the use of computer-readable media with instructions stored therein which, as a result of being executed by the computers or computer systems, instruct the computer or computer system to perform one or more of the methods disclosed herein.

It should be appreciated that all combinations of the foregoing concepts and additional concepts discussed in greater detail below are contemplated as being part of the inventive subject matter disclosed herein.

### BRIEF DESCRIPTION OF THE DRAWINGS

FIG. 1 is a product comparison matrix for three laptops with attributes such as manufacturer, price, and screen size.

FIG. 2 is an illustration of a method for the design and analysis of decision-making strategies.

FIG. 3 illustrates the relationship between independent and dependent hypothesis variables.

FIG. 4 illustrates varying difficulties of identifying utility-maximizing alternatives.

FIG. 5 illustrates one-to-one strategy to alternative mapping.

FIG. 6 illustrates the proportional selection of attributes according to the degree of freedom.

FIG. 7 illustrates a genotype of an alternative set.

FIG. 8 illustrates two different mappings of alternatives to strategies.

FIG. 9 illustrates crossover, mutation, and repair mechanisms on evolving alternative sets.

FIG. 10 illustrates the results of the Genetic Algorithm.

FIG. 11 illustrates a sample screen shot of the CBC matrix.

FIG. 12 provides a view of total strategies used for different screen configurations.

FIG. 13 illustrates the change in decision-making strategies for different WadDif values.

FIG. 14 illustrates a sample result from a GP run

FIG. 15 illustrates an example for mapping decision strategies to alternatives.

FIG. 16 illustrates decision strategies used in the online study.

FIG. 17 illustrates the percentage of explained decisions for different set sizes s.

FIG. 18 illustrates two different mappings of strategies to alternatives.

FIG. 19 illustrates an alternative set (phenotype) through a genotype in a Genetic Algorithm

FIG. 20 illustrates observed and expected (if random) frequencies of the strategies used

FIG. 21 illustrates observed and expected (random) frequencies of strategies (four vs. seven alternatives shown).

FIG. 22 illustrates observed and expected (random) frequencies of strategies (four vs. seven attributes shown).

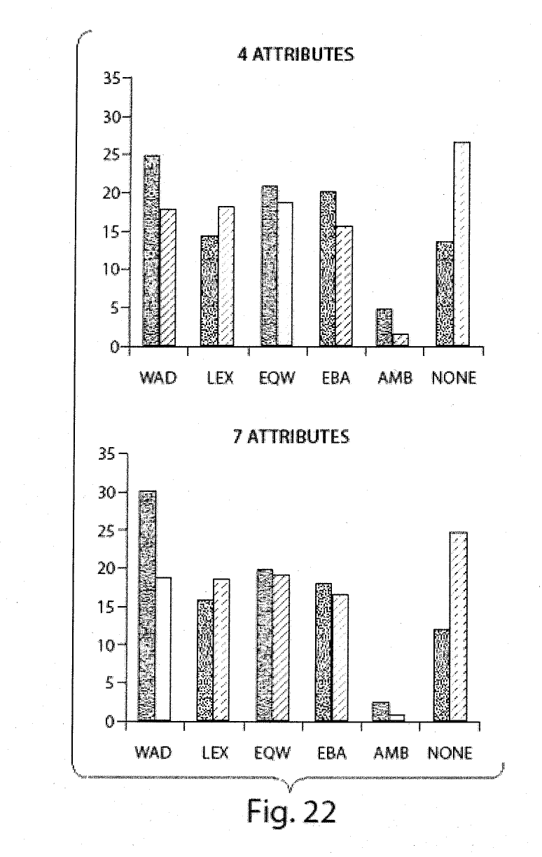

FIG. 23 illustrates observed and expected (random) frequencies of strategies (Low vs. High WAD difficulty).

### DETAILED DESCRIPTION

To provide an overall understanding, certain illustrative embodiments will now be described; however, it will be understood by one of ordinary skill in the art that the apparatus and methods described herein can be adapted and modified to provide apparatus and methods for other suitable applications and that other additions and modifications can be made without departing from the scope of the systems and methods described herein.

Unless otherwise specified, the illustrated embodiments can be understood as providing exemplary features of varying detail of certain embodiments. Therefore, unless otherwise specified, features, components, modules, and/or aspects of the illustrations can be otherwise combined, separated, interchanged, and/or rearranged without departing from the disclosed systems or methods.

The methodology outlined in this disclosure is general enough to be applied to a wide variety of choice settings and respondents, in addition to the specific examples disclosed herein. The genetic algorithm is a natural fit to evolve choice settings defined through multiple attributes and alternatives (shown sequentially and/or simultaneously). The problem space for those problems is so large that some form of a search or optimization technique is necessary. The additional benefit of optimization is the ability to include multiple constraints and control the experiment for a large set of independent variables.

One important problem in the field of decision-making is how to uncover people's decision strategy. Answering this question helps companies to not only design the right products but also to advertise them adequately. In the field of e-commerce, for instance, understanding online shopping behavior is crucial for improving the design of online web stores. In this disclosure, the use of genetic algorithms to identify decision strategies is set forth.

The overall decision making process can be divided into two subprocesses: initial screening and in-depth comparison. The first subprocess consists of search and identification of alternatives to be included in the final discrete choice set (consideration set). The second subprocess is the focus of the experimental design methodology and apparatus set forth in this disclosure and consists of evaluation and comparison of alternatives before the final choice.

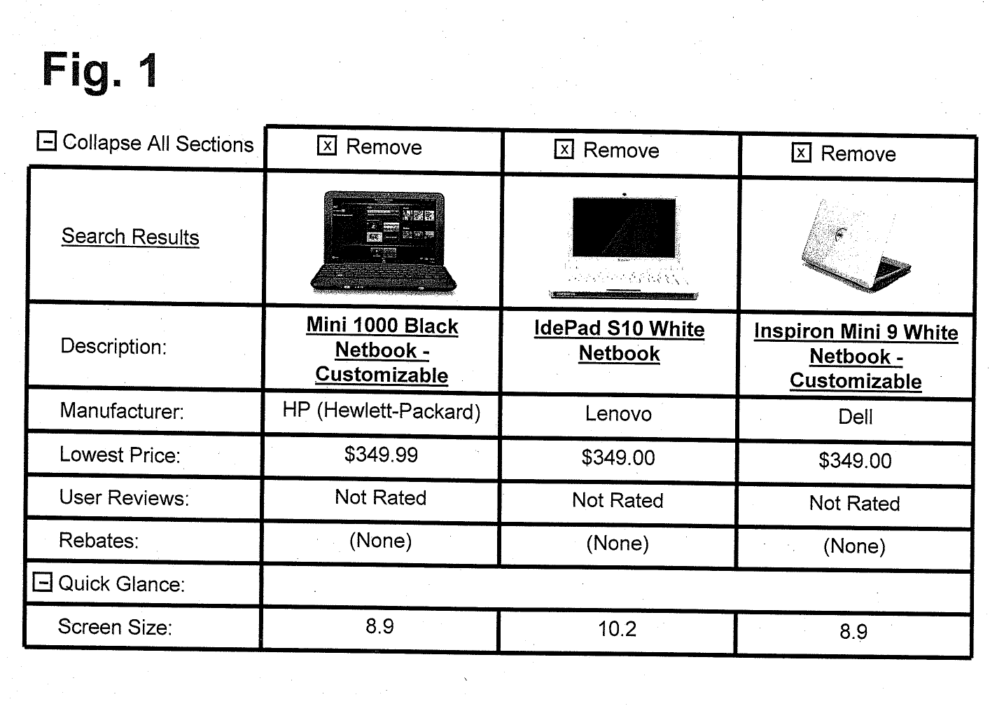

A common way of displaying product information, especially but not exclusively in online stores, is to use an m×n product comparison matrix, where each of the m products displayed is described by n displayed attributes. FIG. 1 presents an example of such a product comparison matrix for three laptops with attributes such as manufacturer, price, and screen size.

When comparing and evaluating the consideration set displayed in a product comparison matrix such as that of FIG. 1, consumers apply decision strategies. A decision strategy has been defined as a “set of operations used to transform an initial stage of knowledge into a final goal state of knowledge where the decision maker feels the decision problem is solved.” J. W. Payne, J. R. Bettman, E. Coupey, and E. J. Johnson. “A constructive process view of decision-making: Multiple strategies in judgment and choice.” Acta Psychologica, 80 (1-3):107-141, August 1992., p. 108.

Most decision strategies assume that the decision maker has a subjective utility function and/or attribute-weights and/or threshold values. A utility function assigns a utility to all possible values of each attribute (e.g., users prefer a screen size of 17″ vs. 19″). An attribute-weight reflects the importance of the attribute for the decision, e.g., a weight of zero for the attribute brand means one does not care about the brand of a product. Finally, a threshold is some minimum level defined for an attribute below which an alternative would be deemed unacceptable, e.g., one is interested only in laptops that cost less than $500.

A recent survey of decision-making literature lists 15 theoretical decision strategies. J. Pfeiffer, R. Riedl, and F. Rothlauf. “On the relationship between interactive decision aids and decision strategies: A theoretical analysis.” Proceedings of the 9th Internationale Tagung Wirtschaftsinformatik (forthcoming), 2009. Therefore, the question arises which strategies are most often used by people. In compensatory strategies, a low value of an attribute of a product can be compensated by a high value on a different attribute. Usually, such strategies require all attribute levels to be considered. Often, this demands high cognitive capabilities from the decision maker. Non-compensatory strategies are heuristics that simplify the choice set and usually narrow down the alternatives without taking into account all attributes. A low value on an attribute removes the alternative from the choice set regardless of values on other attributes. Only recently, researchers formulated a decision tree, which instead of classifying compensatory vs. non-compensatory behavior identifies which out of 13 known decision strategies are applied. R. Riedl, E. Brandstatter, and F. Roithmayr. “Identifying decision strategies: A process-and outcome-based classification method.” Behavior Research Methods, 20 (3):795-807, 2008. Yet, this method does not succeed in distinguishing between all 13 strategies, and empirical validation for this approach is still missing. In this disclosure, a methodology for designing experiments to address these issues is set forth, and some results thereof are presented. It is to be understood that the methodology presented may also be used to study other problems in the field, and this example is exemplary only.

Several findings the field of behavioral economics motivate the experimental design task. First, human decision-making cannot be adequately represented through a utilitymaximization model. Many studies demonstrate that decision-making is often a product of inherent human cognitive biases and simplifying heuristics rather than of extensive and precise calculations. Kahneman, Daniel, and Tversky, Amos, eds., Choices, Values, and Frames. Cambridge, UK: Cambridge University Press, 2000; March, James G. A Primer on Decision Making. How Decisions Happen. New York: The Free Press, 1994; Gilovich, Thomas, Griffin, Dale, and Kahneman, Daniel, eds. Heuristics and Biases. The Psychology of Intuitive Judgment. Cambridge, UK: Cambridge University Press, 2002.

Second, one model of human decision-making does not apply to all people. Sen, Amartya. “Maximization and the Act of Choice.” Econometrica Vol. 65, No. 4 (1997): 745-779; R. Riedl, E. Brandstatter, and F. Roithmayr, “Identifying decision strategies: A process- and outcome-based classification method” Behavior Research Methods, 20 (3):795-807, 2008; Bettman, R. James, and Park, Whan C. “Effects of Prior Knowledge and Experience and Phase of the Choice Process on Consumer Decision Processes: A Protocol Analysis.” Journal of Consumer Research 7 (1980), 234-248. Some people spend more time and energy analyzing alternatives then others. Some rely on a smaller set of intuitions and biases than others. The investigations in this area aim to identify the drivers for selection of particular heuristics and biases.

Third, one model of human decision-making does not apply to all choice environments. Simon, Herbert. “A Behavioral Model of Rational Choice”, in Models of Man, Social and Rational: Mathematical Essays on Rational Human Behavior in a Social Setting. New York: Wiley, 1957; Payne W. John, Bettman R. James, and Johnson J. Eric. The Adaptive Decision Maker. Cambridge, UK: Cambridge University Press, 1993; Gigerenzer, Gerd and Selten, Reinhard (eds.). Bounded Rationality: The Adaptive Toolbox. Cambridge, Mass.: MIT Press, 2001. People adapt their decision-making strategies to the problem they face. Even the most consistent rationalists will resort to some simplification of the decisionproblem when it exceeds some threshold of manageable complexity. By observing the process with which people make decisions researchers in this area have identified and categorized a large set of instances when the same respondents behave differently, i.e., use different decision-making strategies, for different definitions of the choice problem.

The main questions in this research paradigm are, therefore, what decision strategies do people use, why they differ between different people and why they change with a changing environment. The following describes an approach using genetic algorithms to design choice experiments to address the three questions. The method may also be used to address other questions with choice experiments.

The general methodology is composed of four steps. First, there is the Survey and Adaptive Conjoint Analysis step. Preliminary to the application of genetic algorithms as disclosed herein, it is necessary to gather data for each respondent such as attribute weights, utilities, and general knowledge of the category and potential decision-making biases of the respondent. This information then is used at the second step, where a Genetic Algorithm is applied to create alternative sets tailored for each respondent that fulfill the experimental constraints and carry out the desired tests of hypotheses. Third, based upon the results of the genetic algorithm, a Choice Experiment can be carried out, and respondents' decision-making behavior under different choice environments can be determined. Fourth, and finally, Statistical Analysis and Machine Learning can be applied to the results obtained at step 3 to deduce general rules for what heuristics and biases are at play under what conditions. Of ocurse, the genetic algorithm may be employed to design the choice experiments based upon information about respondents gained in other ways than using surveys and Adaptive Conjoint Analysis, and the results need not be analyzed using Statistical Analysis and Machine Learning.

One exemplary embodiment of the methods and apparatus disclosed herein is as follows. In this embodiment, a user designs a choice experiment for seven hundred respondents choosing between cell-phone alternatives. This then is applied to test a variety of hypotheses regarding the drivers of the respondents' decision-making. The genetic algorithm approach is used to design a set of experiments to address two questions. First, what is an accurate model of respondent decision-making behavior for this choice environment? Second, how do different respondent characteristics and different environmental characteristics affect the decision-making behavior?

The user designing the choice experiments may employ a computer, including a display and/or other output device, an input device (e.g., a keyboard or a mouse), and one or more processors, to initiate the process of designing the choice experiments.

The typical choice experiment is designed by researchers and shown to all respondents in an identical manner. Yet, two identical choice experiments, while seemingly the same, can be perceived differently by different respondents. This subjective difference may be due to a significant variation among respondents in terms of their knowledge, affinities, attribute weights, and expected utilities. The methods set forth herein encompass a metric (e.g., complexity of the task) which objectively describes the choice environment by taking into account data for individual respondents. An optimization technique is well-suited to design these experiments. A genetic algorithm searches through a large space of possible choice environments and shows respondents alternative sets that are very close in the values of the objective metric. The result is alternative sets that look different for different consumers, but are as similar as possible along the independent variables of interest.

There are further benefits from this application of evolutionary computation. In addition to being able to control for independent variables more effectively, a genetic algorithm can test a much larger set of variables.

The methodology presented in this paper is a systematic approach to the design of choice experiments that will allow researchers to evaluate a large set of respondent- and environment-defining variables and to uncover accurate models of human decision-making.

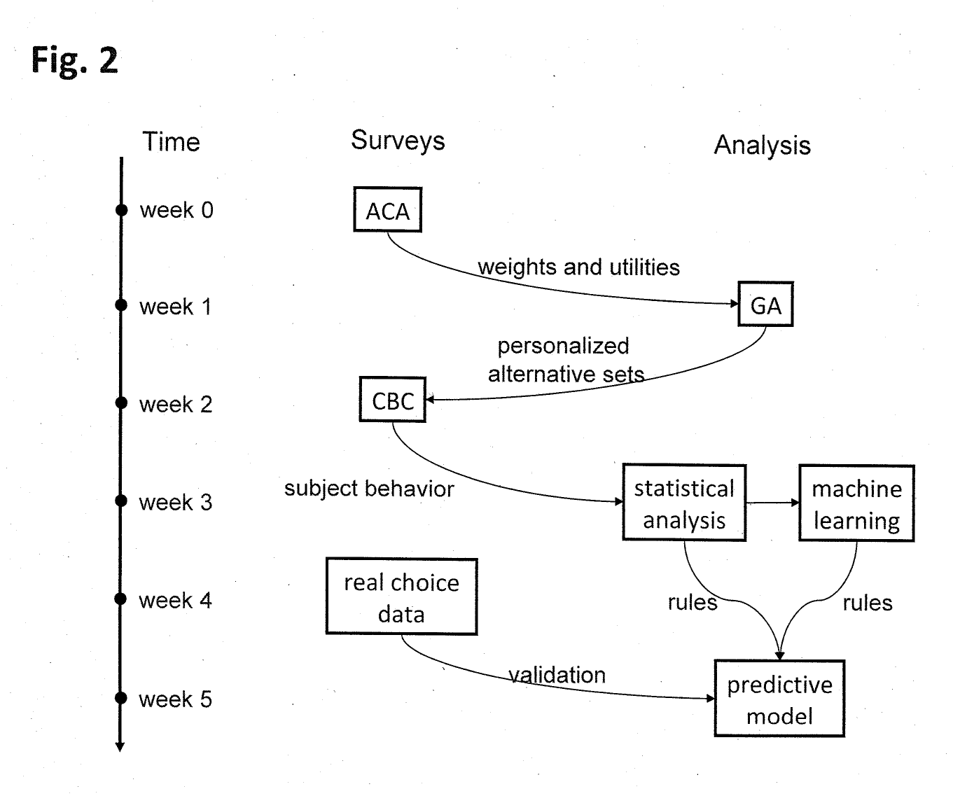

FIG. 2 is a flow chart of an embodiment of the methodology disclosed herein. First, an Adaptive Conjoint Analysis (“ACA”) is used to infer respondent's attribute weights and attribute utilities. ACA presents respondents with pairs of alternatives and depending on respondents' choice it infers the relative importance of different attributes and expected utilities for each attribute value. Green, Paul E. and Srinivasan, V. “Conjoint Analysis in Consumer Research: Issues and Outlook.” Journal of Consumer Research 5 (1978) 103-123.

The ACA data is fed into a Genetic Algorithm that uses it to create a unique set of experiments (a Choice-Based Conjoint analysis (“CBC”)) for each respondent. The same respondents from the ACA are used in the CBC, since the genetic algorithm developed the experiments based upon the characteristics determined for those users in the ACA. The CBC is a survey in which the respondent sees one or more screens of alternative sets and makes a choice. The principal contribution of the genetic algorithm is the creation of alternative sets that uncover the decision-making strategy of each respondent and test how the independent variables affect that process. Of course, the genetic algorithm may be used to design choice experiments that are presented to respondents based on techniques other than CBC.

After all respondents have made their selections the individual and aggregate results can be evaluated to test hypotheses. Pre-defined, theoretical decision-making strategies can be tested or novel strategies can be evolved that explain the respondent behavior better.

Statistical analysis and the machine learning techniques then may reveal the rules that can become a foundation of a predictive model of choice that can be validated with realworld market data, or other techniques may be used.

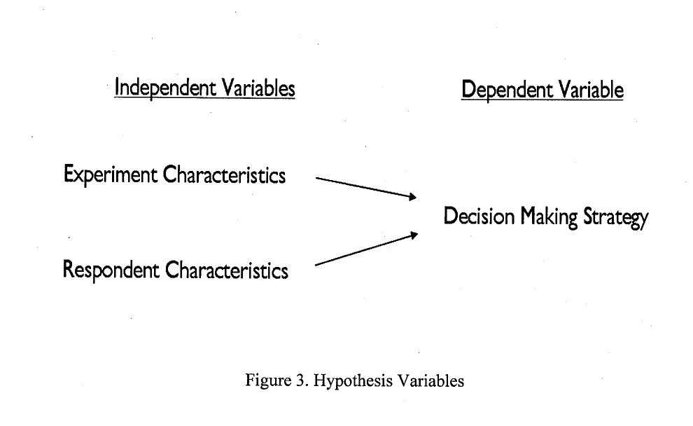

In the example being described, the objective is to analyze how respondent decision behavior changes in response to changing complexity of the decision-making environment. More formally, as set forth in FIG. 3, there are two groups of independent variables (one group pertaining to the respondents' characteristics and the other to the choice environment) that act to produce the dependent variable: the decision-making strategy used.

The complexity of the decision making environment is defined in the example presented by four independent variables: the number of alternatives, the number of attributes, and two additional measures of task difficulty. (Of course, other sets of independent variables may be used with respect to the decision making environment complexity.) The individual characteristics to be analyzed as independent variables in this example are respondents' relative rankings of attribute importance (“attribute weights”), their aspiration levels, and respondent evaluations of attribute utility. (Of course, other sets of individual characteristics may be used.) The following defines the independent variables used in this example in more detail, as well as related hypothesis that can be tested using choice experiments designed according to the methods set forth herein.

Independent Variable 1: Number of Alternatives (NumAlt). The related issue to be explored in this example is whether the number of alternatives presented affects the decision-making behavior. The application of the disclosed methods described herein in this example tests for two levels: 4 alternatives and 7 alternatives presented. It addresses the first hypothesis:

Hypothesis 1: The increase in number of alternatives leads to an increase in heuristics used and a decrease in utility-maximizing behavior.

Independent Variable 2: Number of Attributes (NunAtt). The related issue to be explored in this example is whether the number of attributes affects the decision-making behavior. The application of the disclosed methods described herein in this example tests for two levels: 4 attributes and 7 attributes presented. It addresses the second hypothesis:

Hypothesis 2: The increase in number of attributes leads to an increase in heuristics used and a decrease in utility-maximizing behavior.

Independent Variable 3: Difficulty of Identifying the Utility Maximizing Choice (WadDif). The related issue to be explored in this example is whether the difficulty of identifying the optimal choice affects the decision-making strategy. The alternatives presented can be close or far relative to each other in their utility scores. A difficulty score, di, is assigned for each alternative set according to the following function:

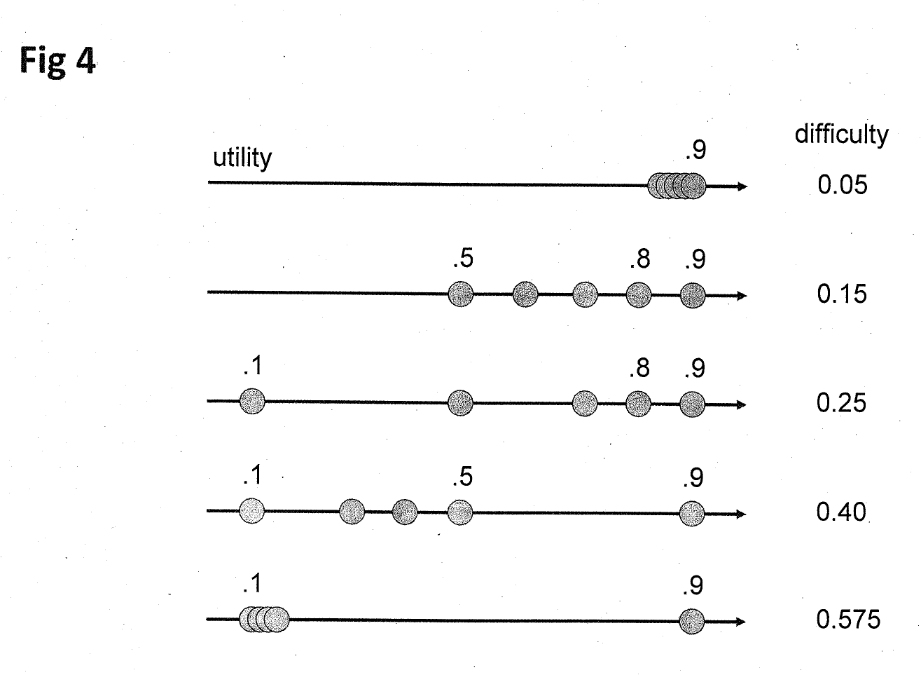

d₁=w₁(u_{best}−u_{second})+w₂(u_{best}−u_{worst}) Equation 1

where u_{best}, u_{second} and u_{worst} are the best, second-best and the worst alternative utilities shown, and w₁ and w₂ are weights used to calibrate the relative importance of two distance metrics: the distance between the best and the second-best alternative and the distance between the best and the worst alternative. FIG. 4 shows five example alternative sets and their difficulty metrics with w₁ and w₂ set to 0.75 and 0.25 respectively. Note that the lower the score the more difficult the decision is. In other words, a high score indicates that there is an alternative which is more easily identified as better than the other alternatives.

The hypothesis to be addressed in the example being described regarding the difficulty of identifying the utility-maximizing alternative is:

Hypothesis 3: The increase in difficulty to identify the utility-maximizing alternative leads to an increase in heuristics used and a decrease in utility-maximizing behavior.

Independent Variable 4. Difficulty of Identifying the Highest Utility Choice for the Attribute with Highest Weight (LexDif). The related issue to be explored in this example is whether the difficulty of identifying the best alternative among the most important attributes affects the decision-making behavior. Some heuristics assume that respondents compare alternatives with respect to the attribute they care most about (attribute with highest weight). Whenever there is one alternative which dominates all others clearly for this more important attribute, the decision has low difficulty. Therefore, a difficulty score d₂ is assigned as follows:

d₂=w₁(pw_{best}−pw_{second})+w₂(pw_{best}−pw_{worst}), Equation 2

where pw_{best}, pw_{second} and pw_{worst} are the part-worths of best, second-best and the worst alternative for the attribute with highest weight shown, and w₁ and w₂ are weights used to calibrate the importance of the distance between the best and the second-best relative to the distance between the best and the worst alternative utilities shown. In accordance with d₁, w₁ and w₂ are set to 0.75 and 0.25 respectively.

The related hypothesis to be addressed in the example being described is:

Hypothesis 4: The increase in difficulty to identify the highest utility choice for the most important attribute leads to an increase in heuristics that use attribute weights and increase in strategies that do not use attribute weights.

Each of the four independent variables NumAlt, NumAtt, WadDif, LexDif, in this example has two levels. NumAlt and NumAtt can be assigned the values 4 and 7 and WadDif and LexDif the levels high (low d₁ and low d₂) and low (high d₁ and high d₂). Therefore, a 4×2 experimental design with 16 different combinations of the independent variables results:

TABLE 1.16
possible experimental combinations

| | | low WadDif | | high WadDif | |
|---|---|---|---|---|---|
| | | low | | low | high |
| | | LexDif | high LexDif | LexDif | LexDif |
| NumAlt = 4 | NumAtt = 4 | 1 | 2 | 3 | 4 |
| | NumAtt = 7 | 5 | 6 | 7 | 8 |
| NumAlt = 7 | NumAtt = 4 | 9 | 10 | 11 | 12 |
| | NumAtt = 7 | 13 | 14 | 15 | 16 |

The easiest choice environment is in the upper-left corner (number 1) with 4 alternatives, 4 attributes, and low WadDif and LexDif. The most difficult choice environment is in the lower-right corner (number 16).

A large sample of respondents and a very precise testing of the choice environment's variables is the objective. Given a great variance in subjective attribute weights and expected utilities, in order to create controlled experiments, each respondent needs to be presented with a choice environment tailored according to individual weights, utilities, and other variables that define the respondent personalities. The creation of such personalized experiments, however, is a non-trivial task that requires an optimization technique.

As described above, the first step in the overall process of the general methodology is the Survey and Adaptive Conjoint Analysis step. The purpose of this step is to gather sufficient information about each participant to permit use of the genetic algorithm approach to design a set of choice experiments tailored to that individual, in order to derive maximum information from the tests presented to that individual. However, as noted, other approaches than ACA may be used to gather the required information for the genetic algorithm.

To begin, in this example the respondent characteristics are classified in two groups, stated and derived. Stated characteristics are respondents' self-reported answers to different survey or poll questions regarding their age, income, level of involvement, etc. Derived characteristics come from data that are deduced through experiments or data gathering. An Adaptive Conjoint Analysis is used to extract respondents' attribute weights and attribute utilities. Additional survey questions ask respondents to point out their aspiration level for each attribute (e.g., “any price below $500 is acceptable”). One of the decision-making strategies studied in this example (the Elimination by Aspects, see below) requires this piece of information.

The respondent data may be used in two ways in this example. First, all decision-making strategies tested in this example use a combination of attribute weights, attribute utilities, and aspiration levels. Therefore, respondent data is needed to identify the alternatives that each respondent would choose if they used their characteristics as identified by the ACA. Second, it is an objective to understand whether there are similarities among respondents who are using similar decision-making strategies. Therefore, in this example a fifth hypothesis is formulated:

Hypothesis 5: Similar respondents (in terms of involvement levels, knowledge, age, aspiration levels, attribute weight distribution, attribute value distribution, etc.) use similar decision-making heuristics under identical choice environments.

Conjoint analysis is a statistical technique to determine how people value the attributes that make up an individual alternative. Respondents choose from a controlled set of alternatives presented, which uncovers their implicit preferences of different attributes.

In the example being discussed, ACA was used to gather data about 724 respondents' attribute weights and attribute utilities (“part-worths”) for fifteen attributes (See Table 2) that define cell phones. Attributes were separated into three groups depending on the degrees of freedom for each (i.e., the number of attribute values they take) using 5 values, 3 values, and 2 values per attribute. The three attribute groups helped hold the information displayed constant for each respondent.

TABLE 2
Attributes and their values for experiment

| Attribute | Attribute Value |
|---|---|
| Sales Ranking | #1 |
| | #3 |
| | #5 |
| | #10 |
| | #20 |
| Form | Fold |
| | Slide |
| | Straight |
| Resolution | 5 mega pixel |
| | 4 mega pixel |
| | 3 mega pixel |
| | 2 mega pixel |
| | 1 mega pixel |
| Image Stabilizer | With |
| | W/out |
| Zoom | 3X |
| | 2X |
| | No zoom |
| TV | With |
| | W/out |
| GPS Function | With |
| | W/out |
| Manufacturer | Brand A |
| | Brand B |
| | Brand C |
| | Brand D |
| | Brand E |
| Weight | 100 g |
| | 105 g |
| | 110 g |
| | 115 g |
| | 120 g |
| Thickness | 10 mm |
| | 15 mm |
| | 20 mm |
| Display | 3.2 |
| | 3 |
| | 2.8 |
| | 2.7 |
| | 2.5 |
| Battery Duration | 700 min |
| | 600 min |
| | 500 min |
| Memory Capacity | 100 MB |
| | 50 MB |
| | 25 MB |
| e-Wallet | With |
| | W/out |
| Bluetooth | With |
| | W/out |

In order to apply a genetic algorithm to design an experiment to test decision-making theories, it is of course necessary to identify the theories to be tested.

The literature describes many different decision-making strategies that humans use to select between a number of presented alternatives. Although of course others could be used, this example focuses on four of those strategies:

Weighted Additive Utility Maximization (WAD). Chooses the alternative with the highest weighted overall utility score that is defined as the sum of the weighted attribute utilities. Anderson, Norman H. “Algebraic Models of Perception,” in E. C. Carterette, & M. P. Friedman (Eds.), Handbook of perception. New York: Academic Press, 1974.

Equal-weight Utility Maximization (EQW). Chooses the alternative with the highest overall utility score that is defined as the sum of an alternative's attribute utilities. Unlike WAD it ignores attribute weights. Dawes, Robyn M. “The Robust Beauty of Improper Linear Models in Decision Making.” American Psychologist 34 (1979) 571-582.

Lexicographic Choice (LEX). Selects the option with the best value on the most important attribute. If there is not one but two or more options with a best value, LEX selects the option with the best value on the second most important attribute, and so on. Fishbum, Peter C. “Lexicographic Orders, Utilities and Decision Rules: A Survey.” Management Science Vol. 20 No. 11 (1974) 1442-1471.

Elimination by Aspects (EBA). Eliminates options that do not meet the aspiration value for the most important attribute. This elimination process is repeated for the second most important attribute. Processing continues until a single option remains. It can happen that EBA chooses several alternatives. The following section explains how those cases are addressed. Tversky, Amos. “Elimination by Aspects: A Theory of Choice.” Psychological Review 79 (1972) 281-299.

The differences between the four strategies are noted in the following table:

TABLE 3
Differences between theoretical decision-making strategies.

| | WAD | EQW | LEX | EBA |
|---|---|---|---|---|
| Utility values ignored | N | N | Y | Y |
| Alternative vs. Attribute based | Alt | Alt | Att | Att |
| Consistent vs. Selective across | C | C | S | S |
| attributes | | | | |
| Consistent vs. Selective across | C | C | S | S |
| alternatives | | | | |
| Elimination of options prior to | N | N | Y | Y |
| final choice | | | | |
| Attribute weights used | Y | N | Y | Y |
| Aspiration levels used | N | N | N | Y |
| Compensatory vs. Non-compensatory | C | C | N | N |
| Quantitative vs. Qualitative | QN | QN | QL | QL |

The previous paragraphs have described the data about respondent characteristics, the choice environments to be analyzed, and the decision-making strategies hypothesized to underlie respondent choices. The creation of sets of choice environments that fulfill the experimental constraints while controlling for the independent variables is a complex task. The Genetic Algorithm (GA) is a search technique well suited to finding optima in problem domains that have a complex landscape of solutions. This example applies a GA to create 16 alternative sets per respondent that fulfill the five experimental design constraints.

The genetic algorithm applied uses respondent data to create personalized choice environments that vary according to the independent variables to be tested. An optimization algorithm is used to create the best possible choice environments for every individual respondent so that her actions and choices clearly uncover what her decision-making process is and how it changes under different environments.

Constraint 1. Create alternative sets with a pre-set number of alternatives presented (4 and 7 according to Independent Variable 1).

Constraint 2. Create alternatives with pre-set number of attributes presented (also 4 and 7 attributes according to Independent Variable 2)

Constraint 3. Create alternative sets that fall into a particular difficulty of identifying the utility maximizing choice (low or high according to Independent Variable 3).

Constraint 4. Create alternative sets that fall into a particular difficulty of identifying the highest utility for the most important attribute (low or high according to Independent Variable 4).

Constraint 5. Create alternatives that map one-to-one with strategies used to choose them.

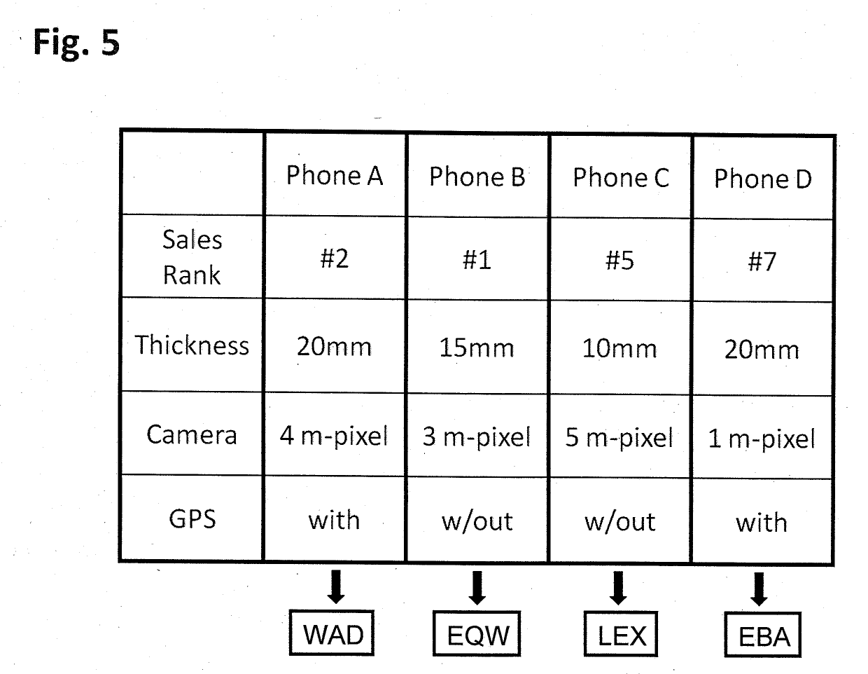

The alternative sets must be designed in a way that no more than one strategy would lead to the choice of each alternative presented (See FIG. 5). If this constraint is met, given the actual choice of the respondent the strategies the respondent did not use can be established with certainty, and the possibility that one of the strategies tested has been used can be noted. Using the entire dataset of all the respondents after the experiment is over, statistically significant effects about strategies used can be recognized, and hypotheses about choice behavior can be tested.

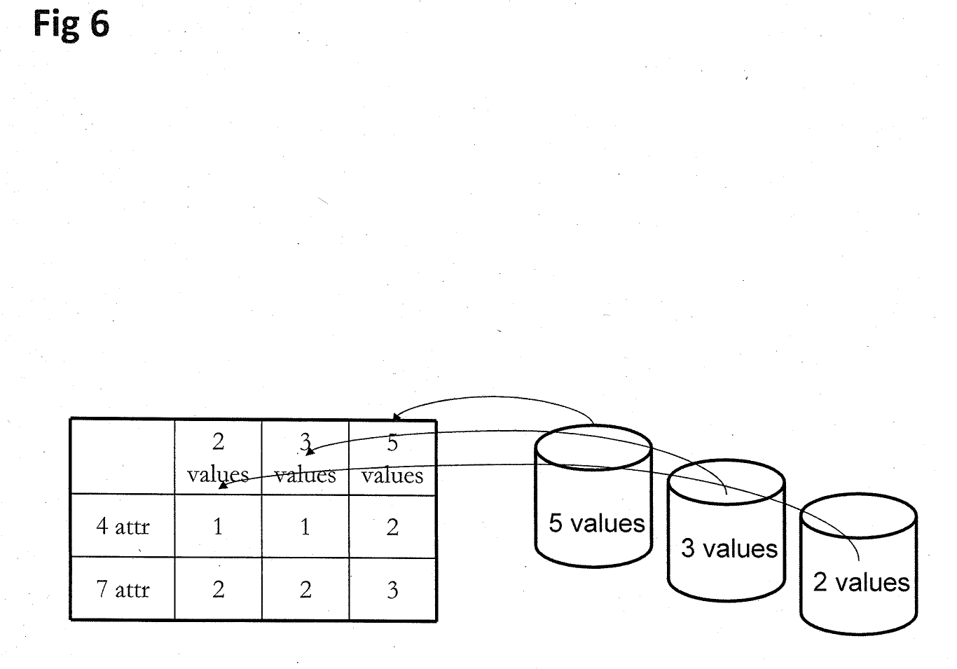

Constraint 6. Create alternative sets with equal complexity of information presented for alternative sets that test the same independent variables (FIG. 6).

Constraint 7. Always show the minimum and maximum part-worth for all attributes.

Recalculation of the part-worths is to be avoided. The utility function is influenced by the range of values which are available for each attribute. To control this effect, the screens always show the levels which contribute the highest and lowest part-worth for each respondent. Eisenfuhr, Franz and Weber, Martin. Rationales Entscheiden. Berlin, Germany: Springer, 2002.

The problem of creating alternative sets that fulfill all criteria is a search problem with a very large combinatorial problem space. To take for example the alternative sets with the largest quantity of information (the 7 alternative, 7 attribute matrix) and given 3 attribute values allowed per attribute yields 2.39*10²³ possible alternative sets. A system of equations would be too difficult to formulate to cover this space and find the optimal alternative set to present to each respondent given the seven constraints. Thus, a Genetic Algorithm was implemented to find 16 alternative sets for each respondent to solve this problem.

One individual in the GA represents one screen for each respondent. Therefore for each respondent 16 GA runs were needed. For a sample of 724 respondents, 11744 genetic algorithms were run. The following sections elaborate in more detail the properties of the Genetic Algorithm (GA) implemented.

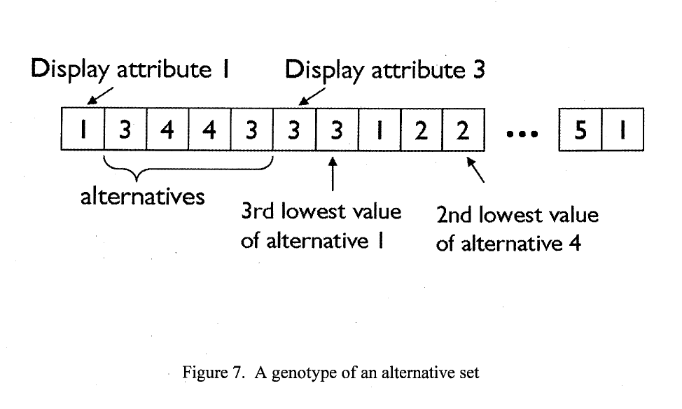

An indirect representation was used where each genotype is a string of integer values. The sequence of numbers that compose the genotype (FIG. 7) are a representation of an alternative set that respondents see (FIG. 5).

The representation consists of 2 different kinds of genes: attribute level genes and attribute group genes. Not all fifteen attributes are shown in each screen and the attribute group genes indicate which ones are included in the particular alternative set. The value of the attribute group gene is the index of a sorted list of attributes by attribute weight. For example, the gene at the first position in FIG. 7 means that the second most important attribute is included in the description of alternatives (Sales Rank in FIG. 5).

Each attribute group gene is followed by as many attribute level genes as there are alternatives shown. The attribute level indicates what the value of the attribute is going to be. The value of the attribute level is the index of a list of part-worths sorted by respondents' subjective utility. So the gene at the second position in FIG. 7 means that the first alternative will have the sales rank with third highest utility for the particular respondent.

Each screen that the Genetic Algorithm creates must be evaluated in terms of how well it satisfies the five experimental constraints. Genetic algorithms use a fitness function to evaluate the generated genotypes. The fitness function used in this example consists of 3 terms: the WadDif fitness, the LexDif fitness, and the mapping fitness.

The Mapping Fitness (m) indicates how well a strategy maps to an alternative. All the data necessary is available (from the ACA) to calculate which alternative the respondent will chose if she uses a particular heuristic. The genetic algorithm uses m to find the ideal combination of alternatives that creates a one-to-one mapping between decision-making strategies and alternatives. The value of m is the number of one-to-one mappings from strategy to alternative.

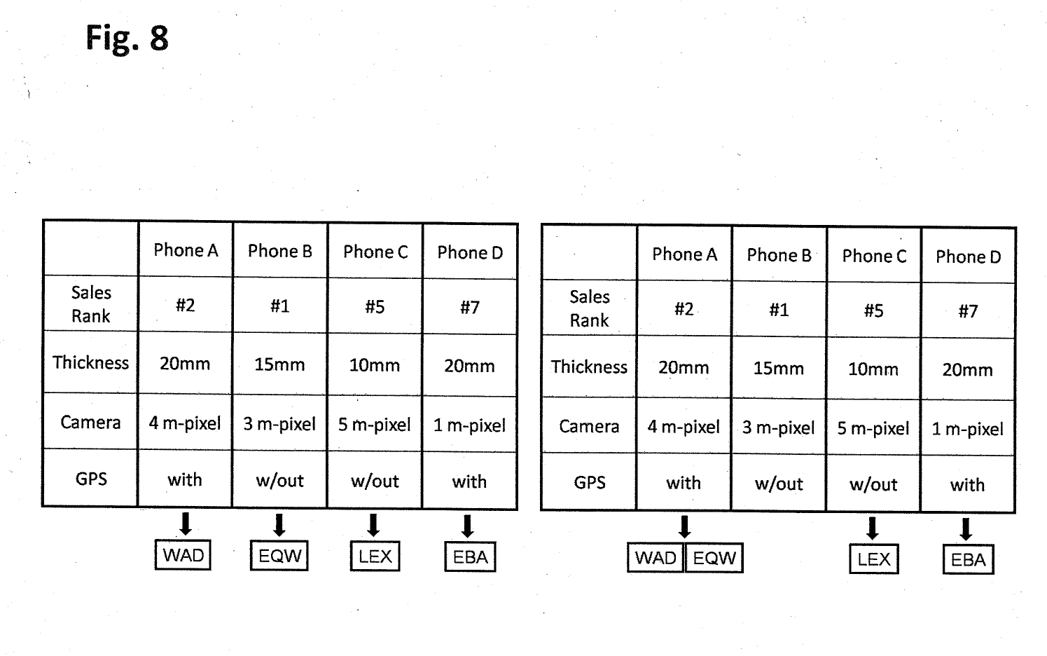

Consider the two examples of FIG. 8.

In the left example m=4 since each strategy maps to one alternative and there are no overlapping mappings. In the right example m=2 (one point for EBA and one point for LEX) since only two strategies map uniquely to a strategy.

WadDif Fitness (d₁) and LexDif Fitness (d₂) indicate the difficulty of identifying optimal alternatives from the set. They are calculated according to equations 1 and 2 above.

The calculation of F is dependent on Independent Variables 3 and 4. The WadDif and LexDif fitness are subtracted from the overall fitness when WadDif or LexDif need to be high, and vice-versa. If, for instance, a scenario is being created with low WadDif (easy) and high LexDif (hard), then the algorithm maximizes d₁ and minimizes d₂. Therefore the fitness is increased by d₁ to reward high d₁ values and decreased by d₂ to penalize high d₂ values.

TABLE 1
Fitness calculations for different independent variables.

| WadDif | LexDif | Fitness |
|---|---|---|
| low | low | F = m + d₁ + d₂ |
| high | low | F = m − d₁ + d₂ |
| low | high | F = m + d₁ − d₂ |
| high | high | F = m − d₁ − d₂ |

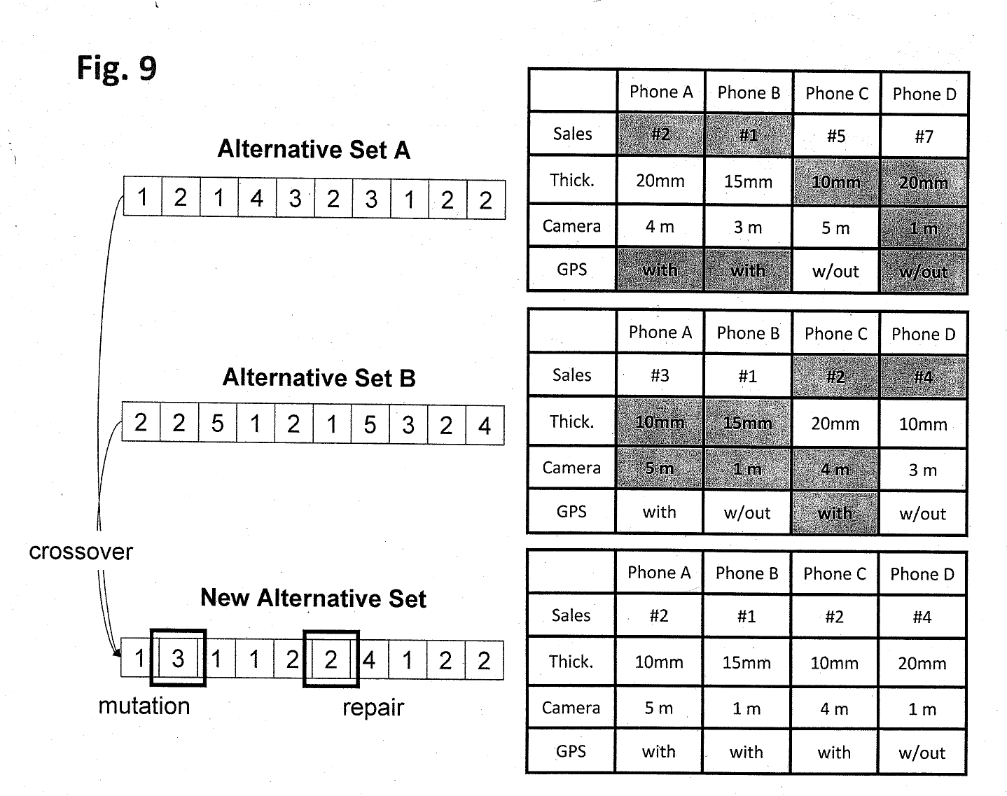

The next step of the genetic algorithm is reproduction or the generation of a new population of solutions from those selected through crossover (recombination) and mutation. A tournament crossover with size 2 and a mutation probability of 2/genome length was used in this example. The algorithm was run for 800 generations of size 125 always keeping the best individual (elitist method) to ensure monotonic increase of the average fitness. FIG. 9 shows a recombination of two alternative sets and the creation of a new alternative set through crossover, mutation, and repair mechanisms.

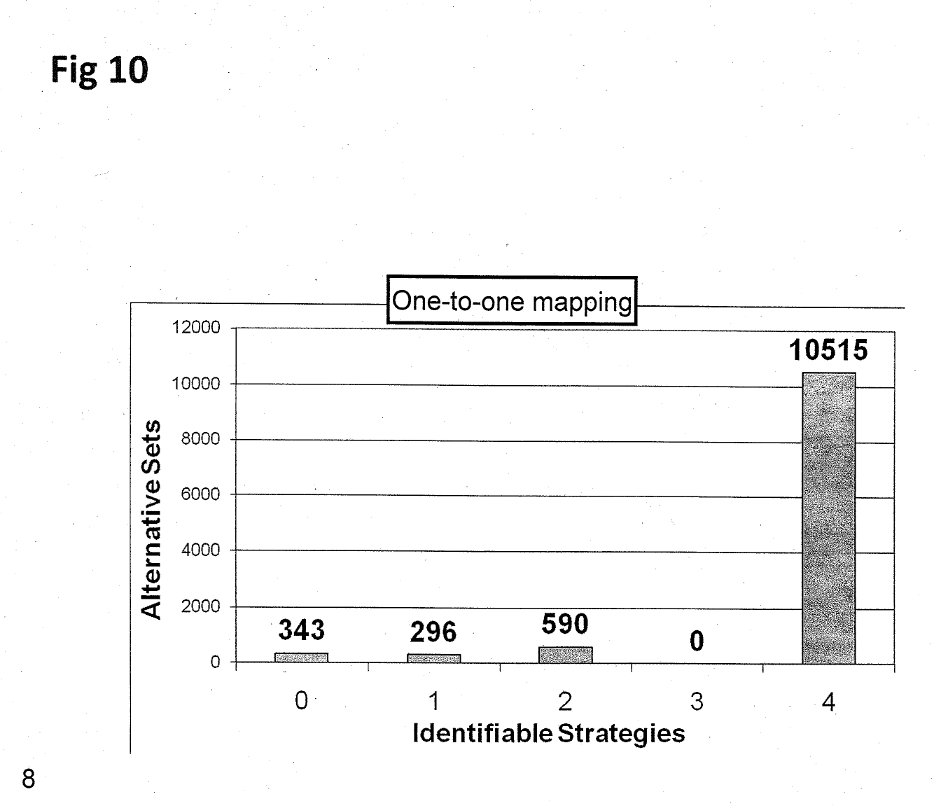

The genetic algorithm created 11744 screens for 724 respondents with average fitness of 3.70 out of maximum 4.0 (92%). In addition to satisfying the constraints of the experimental design the GA also created one-to-one mappings that made the identification of decision strategies easy for a large set of screens. FIG. 10 shows a distribution of clearlyidentifiable strategies. Out of the 11744 screens, 10515 map all test strategies to particular alternatives. For all respondent selections in those screens, it can be concluded with certainty which strategies were not used, assuming that the part-worths and attribute weights measured in the ACA are unchanged.

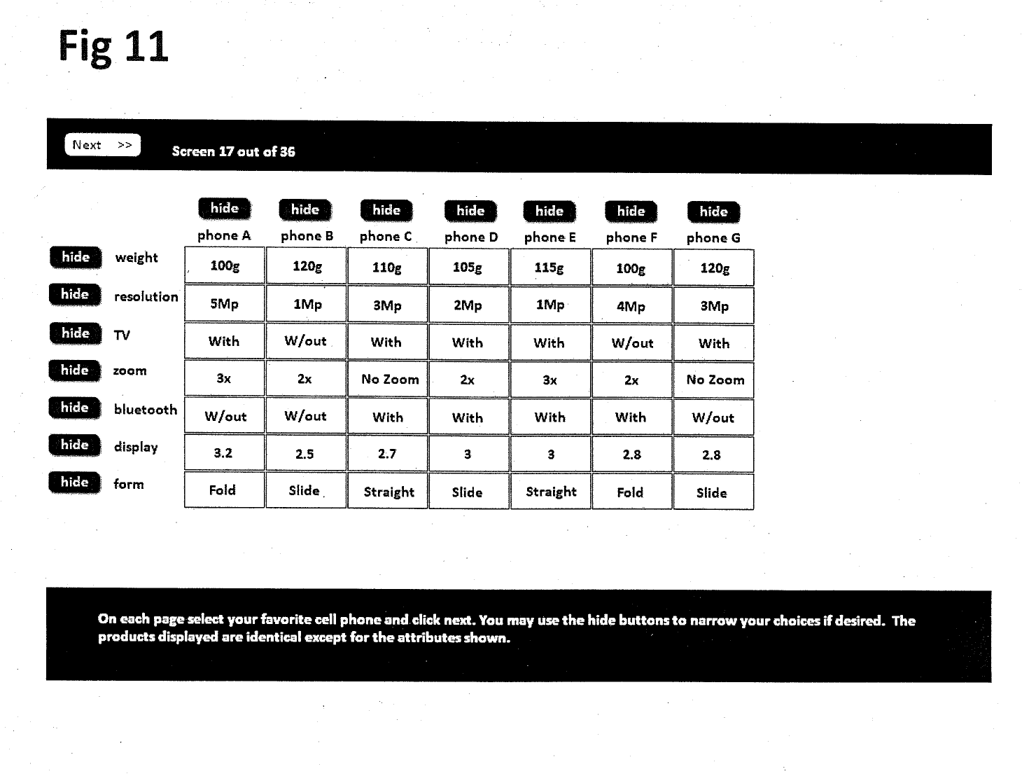

A Choice-Based Conjoint Analysis setup was used to present the GA-created alternative sets to the same respondents that participated in the ACA. FIG. 11 shows a sample screen. Each column represents an alternative (a phone) and each row corresponds to an attribute. Respondents were allowed to hide columns and rows to simplify the choice problem and their actions were recorded. The initial screen had all information displayed.

The time spent on each screen was also recorded. Respondents could move to the next screen only after making a choice (Alternative 5, for example, in FIG. 11). The instructions on the screen notify the respondents to assume that the alternatives are identical on all attributes that are not shown on the screen.

Given the GA mapping of alternatives to strategies the possible strategy used could be identified. When the alternative selected mapped to two or more strategies the respondent strategy was marked ambiguous (AMB). When the alternative selected did not map to any possible strategy the respondent strategy was market as none (NONE).

The following section discusses the statistical analysis of results gathered from the experiment designed as an example using the methods set forth above.

Analysis shows that respondents engaged in a wide variety of decision-making behavior. The often-used assumption that one decision-making model can explain overall behavior does not hold. Across similar decision making environments, different respondents demonstrate consistently different decision-making behavior. However, rarely does one decision-making strategy explain completely the behavior of a given respondent. The results show that certain changes in the choice environment have significant effect in altering the decision-making behavior used by even the most consistent respondents.

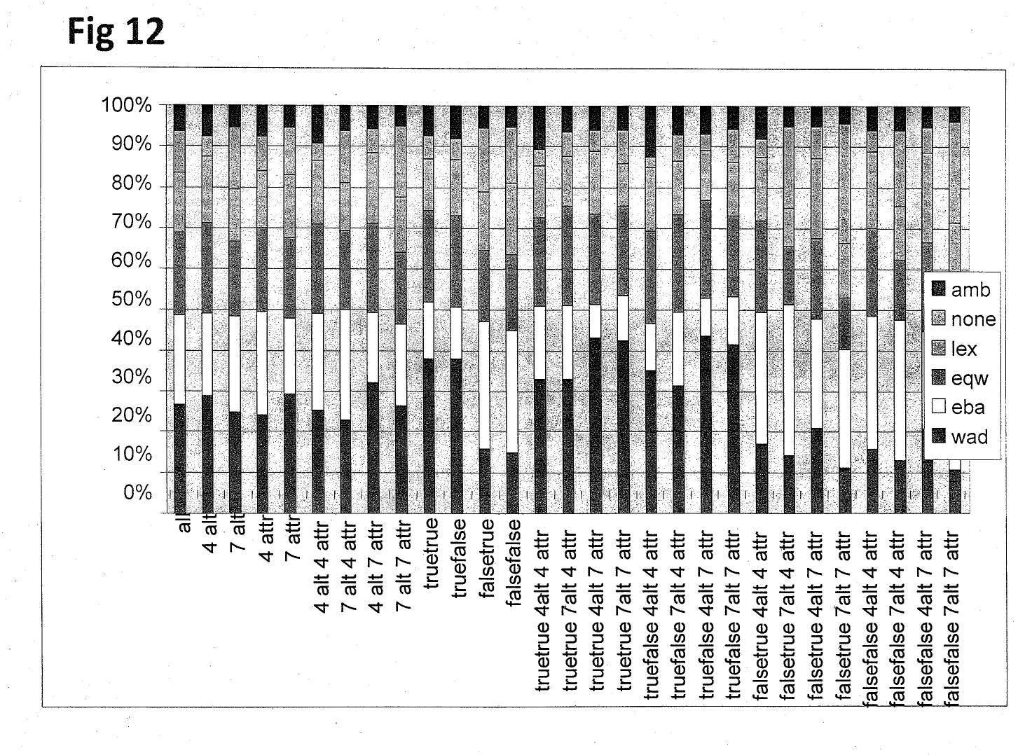

FIG. 12 demonstrates how varied the decision-making is across different respondents and how the changes in environment alter the percentage of strategies used. The y-axis is the total percentage of choices made. The differing shades designate the strategy used. Each bar on the x-axis is a different choice environment.

The findings are a strong indication of the usefulness of the approach disclosed herein and illustrated in this example—in order to understand the decision-making behavior that people engage in, smart experiments are needed, that are going to extract not just the decision-making strategies, but also the meta-rules that govern the conditions under which different strategies apply.

Due to the complexity of the interacting variables regression and logit analyses are inadequate to build a meaningful predictive model. Analysis of the results demands a machine learning technique able to create new decision-making rules and uncover arcane interactions between multiple independent variables.

The following sections describe four main results:

1. Task complexity has significant effects on decision-making strategies.

2. Respondents often use consistent decision-making strategies across different environments.

3. The complexity of the content of the experiment has a greater effect on the decision-making strategies than the quantity of information shown.

4. Regression and logit analyses are insufficient to build predictive models of decision-making using the data gathered during the experiments.

Four hypotheses regarding the effects of the choice environment on the decision-making strategy of respondents were set forth above (Hypothesis 1 to Hypothesis 4).

The analysis strongly supports Hypothesis 1 and Hypothesis 3, but does not support Hypothesis 2 and Hypothesis 4.

The results support Hypothesis 1 as changes in the number of alternatives shown significantly alter the distribution of decision-making strategies used. When there were 7 alternatives shown, respondents used significantly different decision-making strategies then when there are 4 alternatives shown. Moreover, the number of strategies outside of the scope of the strategies tested increased as the number of alternatives grew.

There is little support for Hypothesis 2 given the weak effects of the number of attributes shown on the decision-making strategies used. As a very small effect, a larger number of attributes is positively associated with WADD strategy and negatively with ambiguous choices.

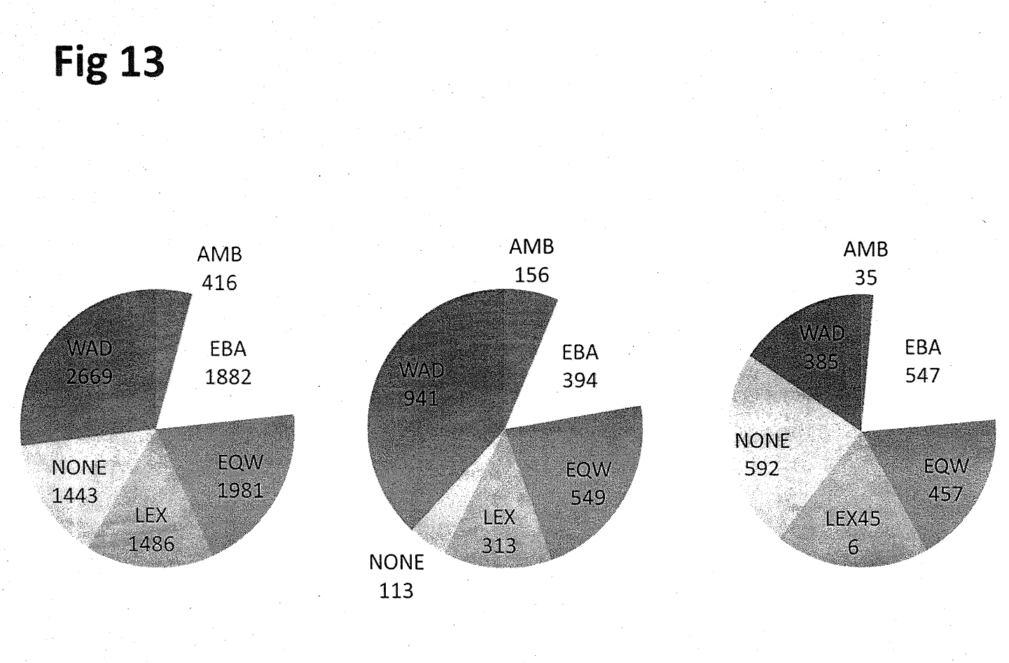

Regarding Hypothesis 3 the results show that when WadDif is low (the optimal alternative is more obvious), the WAD and EQW strategies are used more often. Conversely, when WadDif is high, respondents make many choices that are not consistent with any of the tested decision-making strategies. FIG. 13 shows the different usage of strategies for all screens (left), WadDif low screens (center), and WadDif high screens (right).

Finally, the LexDif had no significant effect on the strategy chosen, lending no support for Hypothesis 4.

The results show little support for Hypothesis 5, given that none of the variables that characterize respondents correlate well with the decision-making behavior (See Table 5). Nonetheless, respondents are often consistent in terms of the decision-making strategies, which is why the respondent ID in Table 5 has the highest contingency coefficient.

TABLE 5
Correlations between respondent characteristics and decision-making behavior

| | | Contingency | Layered | Layered |
|---|---|---|---|---|
| | V-Cramer | coefficient | NrAlt = 4 | Wadd = easy |
| Gender | 0.00 | 0.00 | | |
| AgeGroup | 0.07 | 0.07 | | stronger |
| ReplacementPlan | 0.00 | 0.00 | | |
| InformationLevel | 0.04 | 0.07 | | |
| Adoption | 0.05 | 0.09 | Little weaker | |
| StandingOut | 0.05 | 0.07 | | Little stronger |
| PopularityFollowing | 0.05 | 0.07 | Little stronger | Little stronger |
| Rationality | 0.04 | 0.07 | Little stronger | |
| UsageLevel | 0.06 | 0.10 | Little weaker | Little stronger |
| ReplacementFreq | 0.05 | 0.11 | Little weaker | Little stronger |
| PriceElasticity | 0.03 | 0.05 | | |
| ID_Respondent | 0.45 | 0.70 | | |

Given this consistency, respondents could be clustered using a K-meansing clustering algorithm into groups determined by the probability of using one of the decision-making strategies. Table 6 shows the number of respondents per cluster and the mean with which the clustered respondents use each of the decision-making strategies.

TABLE 6
Respondent Clusters

| | Cluster | | | | | |
|---|---|---|---|---|---|---|
| | EBA | AMB | EQW | LEX | WAD | MIX |
| | Cluster | Cluster | Cluster | Cluster | Cluster | Cluster |
| nRespondents | 63 | 28 | 113 | 77 | 168 | 145 |
| nWAD | 2.52 | 1.50 | 3.16 | 2.95 | 7.76 | 3.77 |
| nLEX | .73 | 1.43 | 1.42 | 7.49 | 2.15 | 1.85 |
| nEQW | 1.43 | 1.00 | 7.42 | 2.36 | 2.14 | 3.13 |
| nEBA | 9.00 | .04 | 2.04 | 1.43 | 2.00 | 4.11 |
| nAMB | .13 | 8.61 | .25 | .35 | .23 | .23 |
| nNONE | 2.19 | 3.43 | 1.72 | 1.42 | 1.72 | 2.91 |

This finding lends support to the claim that respondents remain consistent across different screens of alternative sets. It is unlikely, however, that a sound predictive model can be constructed using the respondent characteristics outlined in Table 5. This finding is a further incentive to focus future research on uncovering possible ties between hidden respondent characteristics (perhaps from observations during the experiment) and decision-strategies used.

The approach disclosed herein of using genetic algorithms to design choice experiments may be applied to test additional strategies. For example, and not by way of limitation, Riedl, Rene, Brandstaetter, Eduard, and Roithmayr, Friedrich, “Identifying Decision Strategies: A Process- and Outcome-based Classification Method.” Manuscript, 2008, list a comprehensive list of decision-making heuristics that include beside the four strategies tested herein: ADD (Additive difference strategy), DIS (disjunctive strategy), DOM (dominance strategy), LIM (least important minimum heuristic), MAJ (majority strategy) and SAT (satisficing heuristic). These strategies have in common the tendency of people to simplify the problem in order to make an efficient, if suboptimal, choice.

Evolutionary algorithms can also be applied in other ways. For example, evolutionary computation can be applied to move beyond theoretical decision-making strategies and use the respondent data from the ACA and the choice experiment to evolve new strategies that better describe the decision-making behavior of respondents. Rothlauf, Franz, Schunk, Daniel and Pfeiffer, Jella. “Classification of Human Decision Behavior: Finding Modular Decision Rules with Genetic Algorithms,” Genetic And Evolutionary Computation Conference Proceedings of the 2005 Conference on Genetic and Evolutionary Computation, apply a genetic algorithm to find decision strategies for a stopping rule problem and find solutions that better explain behavior than the assumed strategies from research literature.

Genetic Programming (GP) can also be applied to create decision-making strategies for the types of choice settings described herein. A GP is a machine learning technique used to optimize a population of algorithms according to a fitness landscape determined by the algorithm's ability to perform a given computational task. GP evolves rules that are represented as tree structures and evaluated recursively.

The four major preparatory steps for genetic programming require the specification of:

(1) Terminal set (e.g., the independent variables of the problem). In the case discussed the terminals are the attribute weights, other consumer variables such as knowledge and biases, the number of alternatives, the number of attributes, the level of utility differentiation, the level of most relevant attribute differentiation, and representations of the evaluation strategies. Of course, others may be used in addition to or in place of some or all of these.

(2) Function set. In the case discussed, simple mathematical operators such as +, −, /, * and Boolean operators such as IF_THEN, AND, and OR.

(3) Fitness measure (for explicitly or implicitly measuring the fitness of individuals in the population). In the case discussed the fitness measure will be the number of correctly simulated respondent choices. If there is a population of 200 individuals and 16 alternative choice sets each, the maximum score can be 3200 (a point for each correct prediction).

Additionally, instead of assigning 0 and 1 for wrong or correct choice estimation the fitness function can be more fine-tuned by estimating a difference between the guessed product and the actual choice of the respondent by comparing their similarity using their attribute values.

(4) Termination criterion. In the case discussed, either getting the best fitness possible or when the number of generations reaches some pre-assigned number.

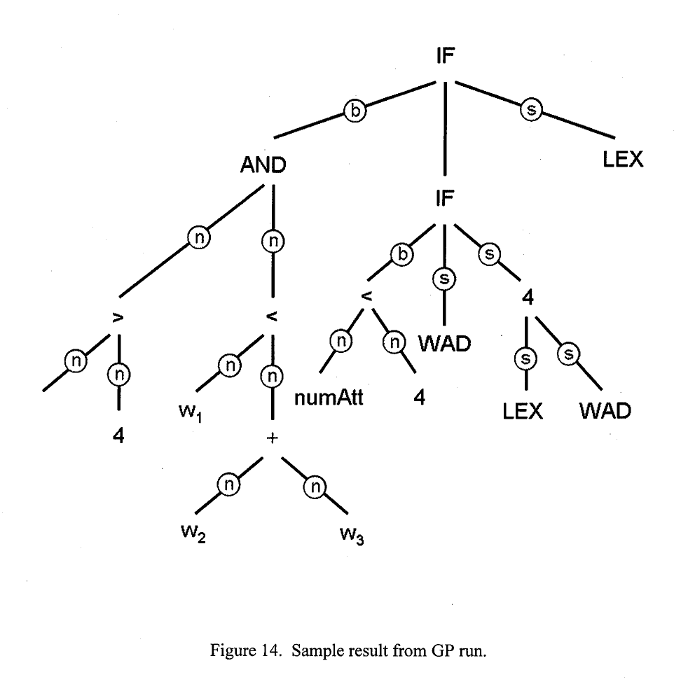

Finally, the end product of the GP would be tree-structures that have decisionenvironment and consumer variables as leaf nodes, and conditional mathematical operators as internal nodes (See FIG. 14). The types returned by the operations are marked in the edges connecting the nodes. In the problem discussed there are three return types: Boolean operators (b), numerical operators (n), and evaluation strategies (s).

The example algorithm in FIG. 14 translates into pseudo-code:

```
if numAlt > 4 and w₁ < w₂ + w₃
    then if numAtt < 4
        then use WAD
        else use LEX until 4 products left and then use WAD
    else use LEX
```

What the above example specifies is that respondents use lexicographic choice unless the number of products presented is bigger than some threshold value and the most important attribute is more important than the second and the third most important attributes combined. If the latter is the case then respondents pick the four most popular products and then use utility maximizing unless the number of attributes is manageable in which case they use utility maximization.

The above implementation of a GP evolves meta-rules for decision-making. It evolves the rules about when respondents use certain decision-making strategies. There are two additional implementations of the GP to evolve particular decision-making strategies. First, instead of using the strategies as terminal nodes all theoretical strategies could be distilled to their individual steps (e.g., compare, select, disregard, evaluate, etc.) and those could be used as building blocks of new strategies. Second, all decision-making strategies could be represented as equations with similar terms and coefficients. The GP then could be used to find the right settings for the coefficients.

The examples just presented using the genetic algorithm approach disclosed showed the cognitive shortcuts people use when faced with choice problems of difficult complexity. The methodology described, however, can be applied to a wide variety of cognitive biases. What follows are three examples of cognitive biases (anchoring bias, focusing effect, and halo effect) that could be analyzed with the methodology disclosed.

Anchoring bias is a human tendency to rely too heavily, or “anchor,” on one trait or piece of information when making decisions. The GA can evolve experiments where respondents evaluate products in sequence before making their choice. The hypotheses to test would revolve around testing under what conditions anchoring effects are more pronounced. Independent variables can be similar to the experiment discussed:

a) the relative differences between the expected utility of the first alternative versus the subsequent ones (to test whether greater discrepancy between expected utilities leads to higher anchoring effects)

b) the number of alternatives and attributes shown (to test whether greater complexity of the problem leads to higher anchoring effects).

Novel independent variables can also be included to test such as,

c) the time the alternatives are shown to the respondents and the time between them.

d) the number of alternatives shown at a time.

Focusing effect is a cognitive bias that occurs when people place too much importance on one aspect of an event, causing an error in accurately predicting the utility of a future outcome. The GA can evolve experiments in which prior to evaluating an alternative set, respondents would see a “simulated message” about one or more attributes. The optimization of when and which attributes to highlight and what alternative sets to show will come from the ACA data about respondent attribute weights and part-worths, as is the case in the application described above.

Halo effect refers to a cognitive bias where the perception of a particular attribute is influenced by the perception of the former attributes in a sequence of interpretations. The GA can use the ACA data to evolve alternative sets in which alternatives are uncovered one attribute at a time. The halo effect will be at play if an alternative with better overall utility is rejected due to early display of attributes with low part-worths. The independent variables can be the same ones for the anchoring bias, but using attribute part-worths rather than alternatives.

The above examples show how the disclosed approach can be extended to new theoretical or evolved decision making heuristics and how the effects of different cognitive biases can be tested. The main piece of the general methodology that will change from implementation to implementation is the definition of the dependent variable. In the implementation discussed, the dependent variable was the usage of the four strategies, but in the examples above the strategies can be binary (whether an effect is at play or not). For example, for anchoring bias an anchoring effect can be defined as a similarity metric between the first and the chosen alternative (effectively having two strategies: use of anchoring or not). A focusing effect can similarly be defined as the distance between the optimal part-worth of the focused attribute and the part-worth of the same attribute in the selected choice.

As an example of the use of genetic algorithms to exploit the results obtained by choice experiments, now consider the following series of tests to investigate which decision strategies people apply when purchasing products displayed in form of a product comparison matrix. This new example examines whether a new class of strategies, called mixed strategies, formed by concatenating elements of pure strategies, are employed. A genetic algorithm is applied to answer two questions that have been so-far unsolved in the decision-making literature. First, how often do people use pure or mixed strategies? Second, when these mixed strategies are used, do people switch their behavior from non-compensatory strategies to compensatory strategies?

The research begins by creating an online experiment where 624 users have to choose from 16 pregenerated choice sets. Each choice set consists of either four or seven products. The example focuses on four decision strategies and analyzes how well they describe the observed choice behavior. Next, a genetic algorithm (GA) is designed that builds mixed decision-strategies composed of the four pure strategies. The goal of the GA is to maximize the number of choices explained. Differences between performance of the four pure strategies and the mixed strategies are analyzed. Finally, four additional pure decision strategies are added, and mixed strategies are evolved using elements from all eight strategies. The results show that 66.44% of decisions made are explained using mixed strategies. A set of four mixed strategies is able to explain 93.3% (75.4%) of respondent choices in search tasks where four (seven) alternatives were presented to the customer.

The presentation of this example is structured as follows. First, the decision strategies used in the analysis are described. Then, a summary of the design of the online study is presented. Next, the new concept of mixed strategies is defined, and the problem of analyzing human decision making as an optimization problem is formalized. Then, design and evaluation of the GA is presented. Finally, the experimental results are summarized and an extension of the proposed concept is shown.

Four standard decision strategies that are commonly used were studied. Four additional strategies were introduced in the experiment. The analysis of four and eight decision strategies are referred to as the BASIC and EXTENDED cases, respectively. First, Multi Attribute Utility Maximization (MAU) is the classic utility maximizing strategy in which a decision maker chooses the alternative with the highest weighted overall utility score, defined by the sum of the products of attribute-weights and utilities of attribute levels. N. H. Anderson, “Algebraic models of perception”, in E. C. Carterette and M. P. Friedman, editors, Handbook of perception. Academic Press, New York, 1974; J. Payne, J. R. Bettman, and E. J. Johnson, “The Adaptive Decision Maker,” Cambridge University Press, Cambridge, UK, 1993. Equal-Weight Utility Maximization (EQW) chooses the alternative with the highest overall utility score, defined in terms of the sum of the alternative's utilities of attribute levels. R. M. Dawes, “The robust beauty of improper linear models in decision making,” American Psychologist, 34:571-582, 1979. This strategy is essentially a simpler version of MAU, where a decision maker ignores attribute-weights. Lexicographic Choice (LEX) selects the alternative with the highest value on the most important attribute (highest attribute-weight). If there is a tie between two or more alternatives, then the user compares the tied alternatives on the second most important attribute, and so on. P. C. Fishburn, “Lexicographic orders, utilities and decision rules: A survey,” Management Science, 20 (11):1442-1471, 1974. Finally, Elimination by Aspects (EBA) is a strategy where the decision maker eliminates alternatives that do not meet the individual's threshold for the most important attribute. This elimination process is repeated for the second most important attribute and continues until the alternative set has been narrowed down to a single remaining option, which is then selected. A. Tversky, “Elimination by aspects: A theory of choice,” Psychological Review, 79:281-299, 1972. MAU and EQW are prominent examples for compensatory strategies; LEX and EBA are non-compensatory strategies. Note that these are the same basic strategies utilized for the above example as well.

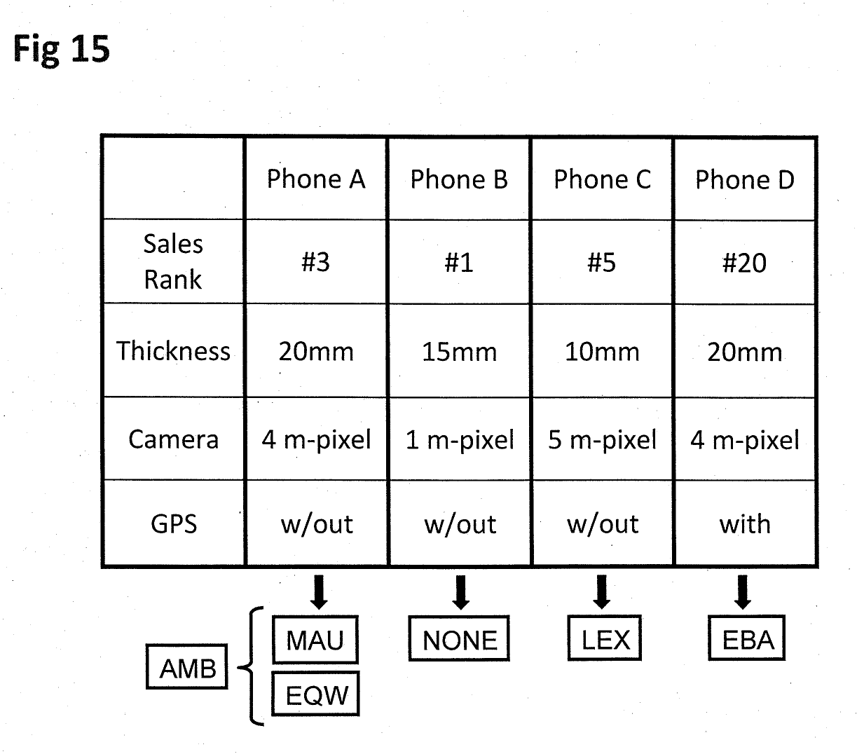

In order to examine which of the above mentioned strategies are actually applied by decision makers, 624 respondents each were presented with 16 product comparison matrices about cell phones from which they had to select one product as their choice. A 2×2×2×2 experimental design was used. The number of alternatives was varied (four or seven), as were the number of attributes (four or seven), and the difficulty of the choice task, which depends on the similarity of utilities for different alternatives (either simple or difficult) and the similarity of utilities for attribute levels along the most important attribute (either simple or difficult). Each respondent's attribute level utilities, attribute-weights, and thresholds were measured by performing a preceding adaptive conjoint analysis (ACA). The ACA data allowed pinpointing which alternative the respondents would choose if they were to use any of the four strategies described above. The 16 choice sets (and the attributes of the alternatives) were designed in such a way that each of the four BASIC decision strategies would lead to the selection of a different alternative. Therefore, in all choice sets, the goal is for each strategy to map to one alternative. As in the example above, a genetic algorithm was used to develop the choice sets. In FIG. 15 the relationship between strategy and respondent choice is illustrated. When a respondent is following LEX or EBA, the attribute-weights and the utility of attribute levels are assigned to the alternatives such that the user choice is either Phone C or Phone D, respectively. Therefore, the design of a choice set also takes the preference function of the respondent into account. When a respondent chooses Phone B, he/she follows none of the BASIC strategies. Using either MAU or EQW leads to Phone A. Such a situation is denoted ambiguous (AMB). FIG. 15 shows an example, where a perfect one-to-one mapping is not achieved as MAU and EQW both map to the same alternative. If the respondent chooses phone A one cannot tell unambiguously if he/she has applied MAU or EQW for the choice. In cases where the number of alternatives is higher than the number of strategies (e.g. four BASIC strategies and seven alternatives), some alternatives do not correspond to a strategy. Such cases, where none of the assumed pure strategies explain the respondent's choice, are labeled as NONE (see phone B in the example). The choice sets of the experiments were designed such that there is minimal overlapping between choice strategies. Given that all respondents have different utility functions, different individual choice sets had to be generated for each user, controlling for the difficulty of the choice task. For some users, it was not possible to generate choice sets such that there is no overlapping between decision strategies resulting in AMB choices.

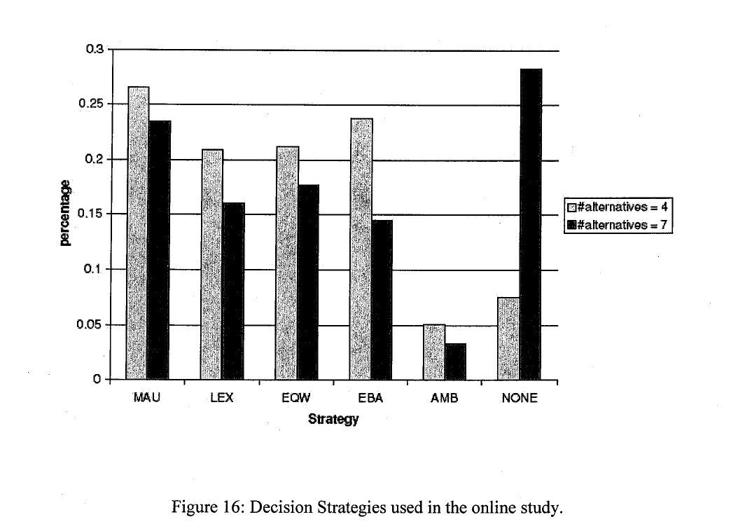

FIG. 16 shows the proportions of strategies found when analyzing the experimental data of the 624 respondents. For four (seven) alternatives, 7.5% (28.0%) of choices were not explained by any of the strategies. The high proportion of unexplained strategies leads to attempts to explain the decisions with eleven strategies that can be found in the literature, J. Pfeiffer, R. Riedl, and F. Rothlauf, “On the relationship between interactive decision aids and decision strategies: A theoretical analysis,” in Proceedings of the 9th Internationale Tagung Wirtschaftsinformatik (forthcoming), 2009, and which were meaningful for this context. Even with the additional seven pure strategies, 5% (21%) of choices remained unexplained for the four (seven) alternatives cases. These results were the motivation for introducing a new class of strategies, called mixed strategies, aimed at explaining a larger proportion of decisions.

Mixed decision strategies are defined as a sequence of pure decision strategies which are sequentially applied by the decision maker. Therefore, the application of each decision strategy sequentially eliminates one or more alternatives from the choice set until only one alternative remains. Mixed strategies are defined as follows:

Definition: A Mixed Strategy is a sequence of m−1 elimination steps, where m is the number of alternatives. An elimination step removes one or more alternatives from the consideration step applying a basic elimination step of a decision strategy. A mixed strategy is applied until either the m−1 elimination steps have been executed or only one alternative is left in the choice set.

Example: Assume a choice task with four alternatives and the following mixed strategy: [EQW² EBA]. According to this strategy, the decision maker applies the three elimination steps EQW, EQW, EBA in sequence. Note that superscripts are used to avoid repetitions. The superscript denotes how often a basic elimination step appears in the strategy. An asterisk denotes a pure strategy (a strategy composed of only elimination steps of the same decision strategy), for instance [EBA EBA EBA] is written as [EBA*]. In this example, in the first two steps (both EQW) the decision maker sums up all utility values of attribute levels of each alternative. Then, he/she eliminates alternatives with the lowest (step 1) and second lowest values (step 2). In the third step (EBA), he/she takes the remaining alternatives and compares them along the most important attribute. All alternatives are eliminated that do not meet the threshold for this attribute. If there is no threshold defined for this attribute, she proceeds with the second most important attribute until at least one alternative can be eliminated.

The application of a mixed strategy should ensure that exactly one alternative remains, so that the decision-maker's choice can be unambiguously explained. The execution of single elimination steps is stopped whenever only one alternative remains. Therefore, not all steps might be executed as some decision strategies eliminate more than one alternative per step. However, applying a mixed strategy can still lead to the case that there are either none or more than one alternative left. If an elimination step removes no alternative, more than one alternative can remain after m−1 elimination steps. For example, this is the case for EBA if all thresholds are met for all attributes and no alternative can be removed. Then, a mixed strategy does not provide sufficient decision support for the user and is therefore invalid to explain the decision. To avoid this case, only mixed strategies that remove at least m−1 alternatives from the choice set are allowed. Second, it can happen that in an elimination step all remaining alternatives are removed from the consideration set. In this case, this step is not executed and the decision maker proceeds with the next elimination step. As an example, the only two remaining alternatives are compared by EBA along the most important attribute. If they both do not meet the threshold, they would both be eliminated leaving the decision maker with no alternative to choose. In this case, the decision maker is assumed to just skip the elimination step.

Decision makers may use different decision strategies; a set of s different mixed strategies is to be sought which best explain the behavior of the decision makers. At the same time, the number of ambiguous mappings is to be minimized to ensure that the set of strategies explain different decisions. Hence, there are two objectives. First, it is desired to find a set of mixed strategies that explains as many user decisions as possible (maximize #explained decisions). Second, it is desired to ensure that different mixed strategies explain different decisions (minimize #ambiguous).

It is assumed that mixed strategies are composed of n BASIC strategies (for n=4, MAU, LEX, EBA, and EQW are considered). Each mixed search strategy consists of m−1 pure strategies that are iteratively applied until only one alternative is left. This yields a size of the search space of n^{(m-1)*s}, where s is the number of different mixed strategies sought and m is the number of alternatives. Table 7 gives an overview of the size of the search space for different m and s and n=4 (BASIC case).

TABLE 7
Size of the search space for BASIC strategies (n = 4).

| m | s | search space size |
|---|---|---|
| 4 | 1 | 64 |
| | 2 | 4096 |
| | 3 | 262,144 |
| | 4 | 16,777,216 |
| | 5 | 1,073,741,824 |
| 7 | 1 | 262144 |
| | 2 | 16777216 |
| | 3 | 68,719,476,736 |
| | 4 | 2.81E+14 |
| | 5 | 1.15E+18 |

The optimization problem was solved by applying a genetic algorithm using the ECJ library from George Mason University. As representation integer vectors were chosen. Each individual represents a set of s mixed strategies. The length of an individual l is the number of mixed strategies per set multiplied by the length of each mixed strategy:

l=s(m−1).

The cardinality of each integer is equal to n, the number of available pure strategies.

The fitness of an individual is computed as follows. One mixed strategy is able to explain a decision if it maps to only the alternative chosen (unique mapping). For each of the 9877 decisions from the experimental data, one fitness point (fᵢ=1) is assigned if at least one of the mixed strategies encoded in the individual explains a decision (iε[1, . . . , 9877]); otherwise fᵢ=0. Therefore, the fitness of an individual is calculated as the sum of fᵢ over the 9877 decisions. This ensures maximizing the number of explained decisions (first objective). In order to also meet the second objective of minimizing the number of ambiguous mappings, a penalty factor is introduced of 1/#ambiguous, where #ambiguous counts the number of strategies mapping to the alternative chosen. If no strategy maps to the chosen alternative (NONE-case), fᵢ−0 and #ambiguous is set to 1, therefore fᵢ/#ambiguous=0. Thus, the fitness function fitness is defined as the sum of the values off I#ambiguous, over the number of decisions.

As one individual is composed of several mixed strategies, it is ensured that only similar mixed strategies are recombined by introducing a problem-specific crossover operator. The problem-specific crossover operator performs a one point crossover in each paired match of two mixed strategies, one from each parent. Mixed strategies are defined as paired if they have a minimal Hamming distance. The Hamming distance counts the number of unequal gene positions of two mixed strategies. In case several mixed strategies have the same Hamming distance, two are randomly chosen for the pairing. As recombination probability 100% is chosen.

As all basic elimination steps have the same phenotypic distance between each other (an EBA step is not assumed to be more similar to an EQW compared to a MAU step), the mutation operator randomly reassigns a new value to a gene with probability 1/l. A GA run is stopped after 250 generations for all cases with seven alternatives and/or s=5, and 150 generations for all other cases.

As shown in table 7 for cases with m=4 and s<3 the search space consists of at most 262,144 solutions. For this size a complete search is still computationally tractable and a heuristic optimization method is unnecessary. The scenario with 3 sets and 4 alternatives is taken as a benchmark for the GA design.

The optimal solution found by a complete search of this space is: [MAU*; EBA*; EQW*]. Therefore, all three strategies in the set are pure. The MAU strategy explains 26.7% of decisions uniquely, the EBA strategy 24.5% and the EQW 21.3%. In total with the percentage for ambiguous mappings (3.22%), this optimal solution explains about 75.6% of the decisions with 4 alternatives.

Tests were run to see if the GA would find the optimal solution as well. This was the case in all 10 test runs. On average the GA found the optimal set in generation 18.56. So the GA needed an average of 3712 evaluations for finding the optimum. Compared to the 262,144 evaluations computed in the complete search, the exhaustive search took 70.62 as many evaluations.

To learn more about the trade-off of both parts of the fitness function, the optimal solutions again were computed with complete search and 10 runs of the GA with a fitness function set only to maximize the number of explained decisions, which is to say, to maximize the sum off over all decisions. The optimal solution is [LEX EQW MAU; EBA*; EQW*] explaining slightly more decisions than in the original fitness function (76.41% vs. 75.64%). Yet, the latter solution increases the number of ambiguous mappings by 1.56 (from 3.22% to 5.01%). Therefore, the slightly improved number of explained decisions is sacrificed for the number of ambiguous mappings. This indicates that the chosen penalty function deals with the trade-off between maximizing explained choices and minimizing ambiguous mappings well.

The main goal of the method is to determine how many decisions the sets of mixed strategies explain, and how much better are mixed strategies at explaining decisions compared to pure strategies. These results are benchmarked with the best sets composed of pure strategies. See table 8. The main outcome is that there is very little improvement for choice sets that are relatively easier for respondents to choose from (i.e., when there are four alternatives present, m=4) but a greater improvement for choice sets that are cognitively more demanding (i.e., m=7).

In table 8 are shown all evolved strategies and the percent uniquely explained by each strategy (in parenthesis). In the columns labeled “exp.” and “amb.” the percentages of explained choices using all s strategies and the percentage of ambiguous mappings is shown. The last column, “‘improv,’” shows the improvement between using pure and mixed strategies. The only improvement for the case with four alternatives is for sets composed of one or two strategies. For s=1, the mixed strategy [EQW²; LEX] explains 34.9% of decisions, improving the explanatory power compared to a pure MAU by 16.9%. For s=2, 56.1% of the decisions can be explained compared to 54.4% which is an improvement of only 3.1%. Here, the optimal set with pure strategies would be [MAU*; EBA*], while with mixed strategies a pure [EBA*] and a mixed [LEX EQW MAU] strategy are obtained. The strategy [LEX EQW MAU] explains 30.2% of decisions, the pure EBA 23.6 and in 2.4% they both explain the same decision. In the case with seven alternatives, mixed strategies increase the explanatory power of for all strategy set sizes, with the maximum improvement being 12.5%.

TABLE 8
Performance of pure vs. mixed strategies for the BASIC case of four strategies.
(All numbers in percent.)

| | | PURE | | | MIXED | | | |
|---|---|---|---|---|---|---|---|---|
| m | s | Optimal Set | exp. | amb. | Found by GA | exp. | amb. | improv. |
| 4 | 1 | MAU* (29.9) | 29.9 | 0.0 | EQW² LEX (34.9) | 34.9 | 0.0 | 16.9 |
| 4 | 2 | MAU* (28.5); EBA* | 54.4 | 1.4 | LEX EQW MAU | 56.1 | 2.4 | 3.1 |
| | | (24.5) | | | (30.2); | | | |
| | | | | | EBA* (23.6) | | | |
| 4 | 3 | MAU* (26.7); | 75.6 | 3.2 | MAU* (26.7); EBA* | 75.6 | 3.2 | 0.0 |
| | | EBA* (24.5) EQW* | | | (24.5); EQW* (21.3) | | | |
| | | (21.3) | | | | | | |
| 4 | 4 | MAU* (25.6); EBA* | 92.6 | 5.0 | MAU* (25.6); EBA* | 92.6 | 5.0 | 0.0 |
| | | (23.8); EQW* | | | (23.8); EQW* (21.2); | | | |
| | | (21.2); LEX* (16.9) | | | LEX* (16.9) | | | |
| 4 | 5 | MAU* (25.6); EBA* | 92.6 | 22.0 | MAU* (25.6); EBA* | 92.6 | 22.0 | 0.0 |
| | | (23.8); EQW* | | | (23.8); EQW* (21.2); | | | |
| | | (21.2); LEX* (0.0); | | | LEX* (0.0); LEX | | | |
| | | LEX* (0.0) | | | (0.0) | | | |
| 7 | 1 | MAU* (26.1) | 26.1 | 0.0 | EBA² EQW² MAU² | 29.0 | 0.0 | 11.1 |
| | | | | | (29.0) | | | |
| 7 | 2 | MAU* (25.0); EBA* | 41.2 | 1.1 | EBA² LEX MAU³ | 46.3 | 0.9 | 12.5 |
| | | (15.0) | | | (27.6); EQW* (17.9); | | | |
| 7 | 3 | MAU* (24.2); | 58.9 | 2.0 | LEX MAU² | 61.6 | 4.5 | 4.6 |
| | | EQW* (17.7); | | | LEX MAU² (22.9); | | | |
| | | EBA* (15.0) | | | EQW* (17.4); EBA⁵ | | | |
| | | | | | EQW (16.9) | | | |
| 7 | 4 | MAU* (23.4); | 71.8 | 3.3 | EQW MAU LEX | 74.0 | 5.7 | 3.1 |
| | | EQW* (17.7); EBA* | | | MAU³ (21.9) EQW* | | | |
| | | (14.5); LEX* (12.8) | | | (17.4); EBA⁵ EQW | | | |
| | | | | | (16.4); LEX* (12.7) | | | |
| 7 | 5 | MAU* (23.4); | 71.8 | 16.2 | MAU* (22.3); EQW* | 75.4 | 14.8 | 5.1 |
| | | EQW* (17.7); | | | (17.3); LEX* (12.4); | | | |
| | | EBA* (14.5); LEX* | | | EQW³ EBA³ (4.3); | | | |
| | | (0.0); LEX* (0.0) | | | EBA LEX EBA⁴ (4.2) | | | |

The results for the number of ambiguous mappings are mixed. In some cases the improved number of explained decisions is achieved at the cost of an increase in the number of ambiguous mappings. In the case for s=3, for instance, the pure strategies map ambiguously to alternatives in 2% of choices made while the new set of mixed strategies achieve 4.5%.

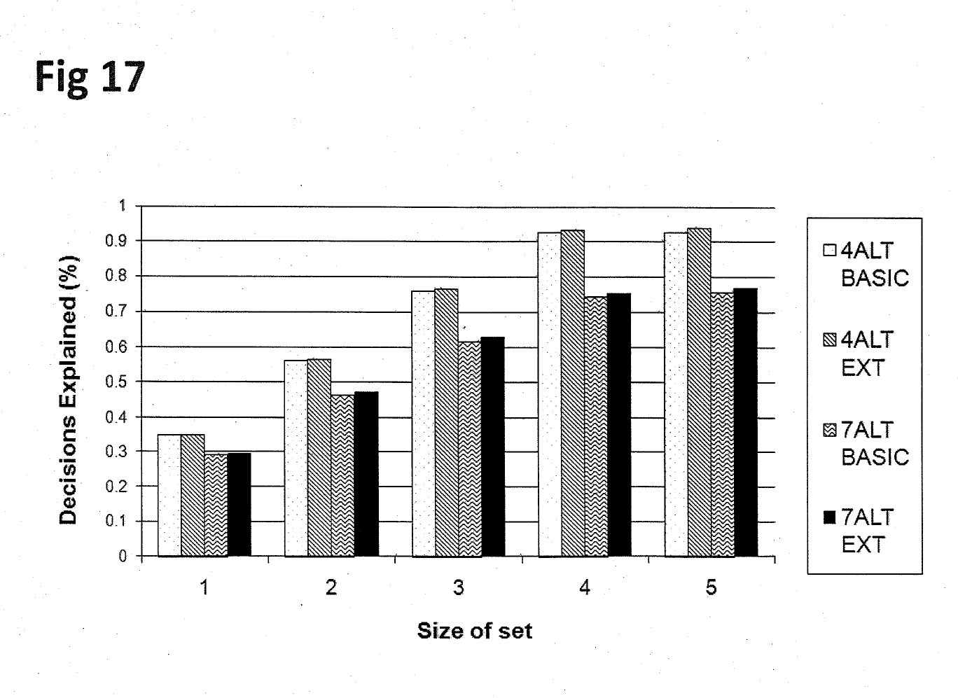

When searching for s decision strategies, there is a tradeoff between finding general search strategies that are attributed to a larger number of decisions and finding specific ones that more accurately describe fewer decisions. F. Rothlauf, D. Schunk, and J. Pfeiffer. “Classification of human decision behavior: Finding modular decision rules with genetic algorithms,” in Proceedings of the Genetic and Evolutionary Computation Conference, pages 2021-2028. ACM Press, 2005. Thus, with increasing s very specific strategies that are well adapted to the behavior of only a few respondents might be obtained, but might be the result of over-fitting. FIG. 17 provides an overview of the explanatory power of different s. At the moment, the graphs for 4ALT BASIC and 7ALT BASIC are of interest. The number of explained respondent choices increases monotonically with the number of mixed strategies allowed per set. However, the margin of improvement diminishes when moving from four to five strategies per set. Furthermore, in the case of s=5, two of the strategies over-fit, explaining only about 4% of decisions. Thus, from these results, a set size of four is the most adequate for explaining the decisions in the experimental setup. With four mixed strategies, 92.6% of decisions could be explained in the four-alternative case and 74% of decisions in the seven-alternative case.

Out of the 30 strategies the genetic algorithm generates there are 10 mixed strategies that explain 35.95% of respondent decisions. One may infer from these numbers that respondents use mixed strategies in a significant number of decisions. In addition, the mixed strategies are surprisingly intuitive. It is rare that there are elements of more than three pure strategies in the evolved strategies even for cases where the mixed strategy is a sequence of six elimination steps. Furthermore, often subsequent elimination steps consist of the same strategy. These simple patterns make a lot of sense from a decision-making perspective as they indicate that respondents deliberately switch between strategies. For the case with seven alternatives and s=3, for instance, the GA evolved three very different strategies [EQW*; LEX MAU² LEX MAU²; EBA⁵ EQW]. One is a pure EBA, the second is a hybrid of LEX and MAU steps, and the third one is entirely EBA that ends with one EQW elimination step. It is interesting to see that LEX and MAU alternate in the second strategy although these two strategies are very different in nature. MAU is computationally intensive whereas LEX is a very simple heuristic.

Many researchers posit that when the choice task is easy (e.g., there are fewer alternatives to choose from) people do not tend to switch their decision strategy (i.e., do not use mixed strategies). G. J. Cook, “An empirical investigation of information search strategies with implications for decision support system design,” Decision Sciences, 24 (3):683-697, May-June 1993; J. W. Payne, “Task complexity and contingent processing in decision making: An information search and protocol analysis”, Organizational Behavior and Human Performance, 16 (2):366-387, 1976. On the other hand, when there are plenty of alternatives to choose from people use a non-compensatory strategy to quickly eliminate some options first and then apply a compensatory strategy to choose from the narrower choice set. The only non-compensatory strategies used in this case are LEX and EBA. While so far researchers could only speculate about switching decision strategies mid-problem and rely on verbal protocols or process tracing, thanks to the application of the GA the first analysis of this problem using only information about the decision outcomes an be offered.

For the easy choice tasks in the experiment (when only four alternatives were shown) two mixed strategies were evolved out of fifteen (see table 8). The strategy [LEX EQW MAU] confirms the experimental results of previous researchers (first non-compensatory, then compensatory). However, for the case with s=1 the best mixed strategy found is composed out of two EQW elimination steps followed by one LEX, an obvious occurrence of a compensatory strategy followed by a non-compensatory. For the choice tasks consisting of seven alternatives, the GA evolved eight mixed strategies out of fifteen. Four of these confirm the hypothesis that people use non-compensatory strategies at the beginning of the process. Nevertheless, two mixed strategies start with a compensatory strategy followed by at least one non-compensatory strategy: [EQW MAU LEX MAU³] and [EQW³ EBA³] are these exceptions explaining 21.9% and 4.3% of decisions respectively. In sum, these evolved strategies constitute a finding that is mostly consistent with the experimental approaches to the problem of mixed strategies, but also point to significant exceptions such as [EQW MAU LEX MAU³] which explains the majority of decisions when m=7 and s=4.

The explanatory power of the mixed strategies perhaps can be improved by allowing new elimination steps taken from other decision strategies. The following four strategies are taken from literature: additive difference strategy (ADD), frequency of good/bad features strategy (FRQ), majority strategy (MAJ), and majority of confirming dimensions strategy (MCD). For a description of the strategies see J. Pfeiffer, R. Riedl, and F. Rothlauf, “On the relationship between interactive decision aids and decision strategies: A theoretical analysis,” in Proceedings of the 9th Internationale Tagung Wirtschaftsinformatik (forthcoming), 2009. These additions increase the size of the search space to 1.24E⁺²⁷ for the choice sets with seven alternatives and s=5.

Table 9 summarizes the results for this extended version. (The improvements for explained decisions (exp.) from the extended strategies in relation to the basic and pure case are shown in the last two columns.) For choice sets with four alternatives, the explanatory power is not significantly improved. In the cases with seven alternatives, the new mixed strategies explain up to 2.1% more than with the mixed version of the four BASIC strategies and up to 14.9% compared with the set composed of only PURE strategies. Hence, adding four more strategies for the search space causes only a minor increase in explanatory power, even as the percentage of ambiguous mappings is reduced.

A figure similar to FIG. 17 for the extended strategies (EXT) leads to the same conclusion as before. The choice of four strategies per set seems to be the most adequate (62.8% for s=3, 75.3% for s=4, and 76.7% for s=5 and seven alternatives).

Out of the 30 strategies newly generated by the genetic algorithm across all cases, 20 are mixed strategies that explain 66.44% of the choices made—double the amount explained by BASIC strategies. This result strengthens the result that mixed strategies can explain decision behavior better than pure strategies.

ADD is applied frequently (22% of the time), FRQ in 11% of the elimination steps, whereas the MAJ elimination step is used only twice and the MCD elimination step never. To conclude, although the extended version of strategies does not increase the explanatory power by a lot compared to the mixed case of BASIC strategies, ADD and FRQ are frequently applied strategies and should be considered in further analysis.

In terms of patterns of switching behavior the extended mixed strategies do not offer corroborating evidence for the claim that people use non-compensatory steps before compensatory steps in a decision process. All four newly added strategies are compensatory. Fourteen mixed decision strategies begin with compensatory strategies and six with non-compensatory steps.

TABLE 9
Performance of mixed strategies with extended set of strategies compared to runs
with BASIC case for mixed and pure strategies. (All numbers are in percent.)

| | | EXT | | | BASIC | | PURE | | improvement | |
|---|---|---|---|---|---|---|---|---|---|---|
| m | s | strategies found by GA | exp. | amb | exp. | amb | exp. | amb | MIXED | PURE |
| 4 | 1 | EQW² LEX (34.9) | 34.93 | 0.0 | 34.9 | 0.0 | 29.9 | 0.0 | 0.0 | 16.9 |
| 4 | 2 | LEX ADD MAU (29.9); | 56.3 | 3.0 | 56.1 | 2.4 | 54.4 | 1.4 | 0.4 | 3.5 |
| | | FRQ EBA²(23.7) | | | | | | | | |
| 4 | 3 | MAU* (26.7); EBA* (24.5); | 76.4 | 3.0 | 75.6 | 3.2 | 75.6 | 3.2 | 1.0 | 1.0 |
| | | EQW; ADD² (22.0) | | | | | | | | |
| 4 | 4 | MAU* (25.6); EBA* (23.7); | 93.3 | 5.0 | 92.6 | 5.0 | 92.6 | 5.0 | 0.8 | 0.8 |
| | | ADD* (22.0) LEX* (16.9) | | | | | | | | |
| 4 | 5 | EQW MAU² (20.9); | 93.7 | 17.0 | 92.6 | 22.0 | 92.6 | 22.0 | 1.3 | 1.3 |
| | | EBA FRQ EBA (19.4) | | | | | | | | |
| | | ADD* (19.4); | | | | | | | | |
| | | LEX* (16.1); MAU² FRQ (0.5) | | | | | | | | |
| 7 | 1 | MAJ EBA ADD MAU² LEX (29.6) | 29.6 | 0.0 | 29.0 | 0.0 | 26.1 | 0.0 | 1.9 | 13.2 |
| 7 | 2 | FRQ EBA LEX MAU³ (27.8); | 47.3 | 0.0 | 46.3 | 0.9 | 41.2 | 1.1 | 2.1 | 14.9 |
| | | ADD² EQW ADD³ (18.6) | | | | | | | | |
| 7 | 3 | LEX MAU² LEX MAU² (24.0); | 62.8 | 3.0 | 61.6 | 4.5 | 58.9 | 2.0 | 2.0 | 6.7 |
| | | ADD³ EQW² ADD (18.0); | | | | | | | | |
| | | FRQ² EBA³ LEX (17.3) | | | | | | | | |
| 7 | 4 | ADD² MAU⁴ (22.9); | 75.4 | 5.0 | 74.0 | 5.7 | 71.8 | 3.3 | 1.8 | 5.0 |
| | | ADD EQW ADD EQW ADD² (17.9) | | | | | | | | |
| | | FRQ² EBA³ EQW (16.9); | | | | | | | | |
| | | LEX* (12.8) | | | | | | | | |
| 7 | 5 | ADD MAU LEX MAU³ (21.8); | 76.7 | 13.0 | 75.4 | 14.8 | 71.8 | 16.7 | 1.7 | 6.9 |
| | | MAJ ADD EQW ADD³ (16.4); | | | | | | | | |
| | | LEX* (12.5) | | | | | | | | |
| | | EBA² FRQ EBA³ (9.3); | | | | | | | | |
| | | LEX ADD MAU FRQ ADD FRQ | | | | | | | | |
| | | (4.0) | | | | | | | | |

The use of a genetic algorithm to develop methods to answer two questions is disclosed herein: how often do people use pure and mixed strategies, and when mixed strategies are used, do people switch their behavior from non-compensatory strategies to compensatory strategies? To answer the first, it was shown that the mixed strategies the GA evolved have a significant explanatory power. A set of four mixed strategies explains the decision behavior best. 93.3% and 75.4% of decisions when four and seven alternatives are presented to respondents can be explained, respectively, with only 5% of ambiguous mappings in both cases. A key result is that when the choice task is relatively easy (in cases when only four alternatives were shown) pure strategies are adequate to explain the decision behavior. However, when the choice task is harder (in cases when seven alternatives were shown) the mixed strategies can offer a more detailed understanding of the decision process even when they offer marginal improvement in the explanatory power. Regarding the common hypothesis that people use non-compensatory strategies initially before reverting to compensatory strategies in the decision making process, the answer depends on the task complexity as well as the number of decision strategies included in the analysis. The only confirming evidence for this hypothesis is for cases when seven alternatives were shown and only the four original strategies were used in the analysis. In conclusion, the concept of mixed strategies is a useful one and the application of a GA to the problem of choice analysis can offer improvements to current decision-making theories.

A further embodiment of the methods and systems disclosed herein will now be addressed. Prior research has produced three, almost undisputed, conclusions. First, choice is more often a product of inherent cognitive biases and simplifying heuristics than of utility maximization. Simon, Herbert A. 1955, “A Behavioral Model of Rational Choice,” The Quarterly Journal of Economics 69 (1) 99-118., March, James G. 1994. A Primer on Decision Making: How Decisions Happen. New York: The Free Press, Kahneman, Daniel and Tversky, Amos, eds. Choices, Values, and Frames. 2000. Cambridge, UK: Cambridge University Press. Gilovich, Thomas, Griffin, Dale, and Kahneman, Daniel, eds. 2002. Heuristics and Biases: The Psychology of Intuitive Judgment. Cambridge, UK: Cambridge University Press. Second, the characteristics of the choice environment affect the decision strategies people use. Payne, John W., Bettman James R., Johnson Eric J. 1993. The Adaptive Decision Maker. Cambridge, UK: Cambridge University Press, Gigerenzer, Gerd and Selten, Reinhard, eds. 2001. Bounded Rationality. The Adaptive Toolbox. Cambridge, Mass.: MIT Press. Third, different people might use different decision-making strategies even when presented with the same choice environment. Bettman, James R. and Park Whan C. 1980. “Effects of Prior Knowledge and Experience and Phase of the Choice Process on Consumer Decision Processes: A Protocol Analysis.” Journal of Consumer Research 7, 234-248., Bettman, James R. and Park Whan C. 1980. “Effects of Prior Knowledge and Experience and Phase of the Choice Process on Consumer Decision Processes: A Protocol Analysis.” Journal of Consumer Research 7, 234-248. Despite calls for their integration with the marketing science paradigm, Shugan, Steven M. 2006. “Are Consumers Rational? Experimental Evidence?” Marketing Science 25 (1) 1-7., Thaler, Richard H.2008. “Mental Accounting and Consumer Choice Anatomy of a Failure.” Marketing Science 27(1) 12-14, these findings are rarely used in the current marketing research tools. This further embodiment permits a multi-alternative, multi-attribute choice experiment and its subsequent analysis. The experiment is similar to common stated preference analysis tools, but it integrates the three main conclusions of adaptive decision-making. It tests the decision-making strategies respondents may use and uncovers how the use of those strategies changes depending on the task environment.

The complexity of the design of this embodiment requires an optimization algorithm with two objectives. The first objective is that for every alternative set presented to a respondent, all assumed decision-strategies that the respondent may use lead to a unique alternative. In other words, a one-to-one mapping is to be created between strategies and alternatives. The second objective is that every alternative set controls for the variables that define the task environment, so different hypotheses about the effects of environmental variables on decision-strategy used can be tested.

The embodiment designed and presented here derives the frequency of respondent usage of two pairs of commonly explored decision strategies. Weighted Additive Difference (WAD) and Equal Weight Additive Difference (EQW) are two utility functions used in most conjoint analyses and normative models of decision-making. Anderson, Norman H. “Algebraic Models of Perception” in E. C. Carterette, & M. P. Friedman, eds. 1974. Handbook of perception. New York: Academic Press., Dawes, Robyn M. 1979. “The Robust Beauty of Improper Linear Models in Decision Making.” American Psychologist 34 571-582., Payne, John W., Bettman James R., Johnson Eric J. 1993. The Adaptive Decision Maker. Cambridge, UK: Cambridge University Press. Lexicographic choice (LEX) and Elimination by Aspects (EBA) are decision heuristics often explored by behavioral economists and cognitive psychologists. Fishburn, Peter C. 1974. “Lexicographic Orders, Utilities and Decision Rules: A Survey.” Management Science 20 (11) 1442-1471., Tversky, Amos. 1972. “Elimination by Aspects: A Theory of Choice.” Psychological Review 79 281-299. As a defining characteristic of the task environment its cognitive complexity is chosen. Ford, Kevin J., Schmitt, Neal, Schechtmann, Susan L., Hults, Brian M., and Doherty, Mary L. 1989. “Process tracing methods: Contributions, problems and neglected research questions.” Organizational Behavior and Human Decision Processes 43 75-117; Bettman, James R. and Park Whan C. 1980. “Effects of Prior Knowledge and Experience and Phase of the Choice Process on Consumer Decision Processes: A Protocol Analysis.” Journal of Consumer Research 7, 234-248., Payne, John W., Bettman James R., Johnson Eric J. 1993. The Adaptive Decision Maker. Cambridge, UK: Cambridge University Press. Task complexity is defined as a function of four variables. Based on these variables four hypotheses are tested, which state that an increase in task complexity leads to a decrease in usage of utility maximization, (i.e., WAD and EQW) and an increase in usage of heuristics (i.e., EBA and LEX). In addition, a fifth hypothesis is tested, which states that respondents are consistent in using one preferred strategy and can be clustered accordingly.

The results obtained lead to three conclusions. First, no strategy alone explains more than 28% of choices. Second, the number of alternatives presented and the difficulty of identifying the utility maximizing choice are the two variables with a significant effect on some of the strategies used. Third, meaningful clusters of respondents are created based on their decision-making strategies.

This discussion proceeds as follows. In the next portion current approaches to design adaptive decision-making experiments are reviewed. Then, the decision-strategies, the hypotheses, the data needed, and the optimization of choice sets of the experiments are formalized. Next, the statistical evaluation of the hypotheses is presented. Finally, the findings are discussed.

The various approaches that researchers take to derive the respondents' decision strategies for multi-alternative, multi-attribute choice problems broadly fit into either a procedural or a structural category. Harte, Joanna M. and Koehle, Pieter. 2001. “Modeling and Describing Human Judgement Processes: The Multiattribute Evaluation Case.” Thinking and Reasoning 7(1) 29-49. Procedural approaches infer the decision strategy by observing the sequence of actions respondents take before stating their final choice. Ford, Kevin J., Schmitt, Neal, Schechtmann, Susan L., Hults, Brian M., and Doherty, Mary L. 1989. “Process tracing methods: Contributions, problems and neglected research questions.” Organizational Behavior and Human Decision Processes 43 75-117. Common methodologies are verbal protocols, Payne, John W., Bettman James R., Johnson Eric J. 1993. The Adaptive Decision Maker. Cambridge, UK: Cambridge University Press, computerized process tracking tools, Cook, Gary J. and Swain, Monte R. 1993. “A computerized approach to decision process tracing for decision support system design.” Decision Sciences 24 931-952., Jasper, J. D. and Shapiro, Jennifer. 2002. “MouseTrace: A better mousetrap for catching decision processes.” Behavior Research Methods 34 364-374., and eye-tracking. Russo, Edward J. and Rosen, Larry D. 1975. “An eye fixation analysis of multialternative choice.” Memory and Cognition 3 267-276. Lohse, Gerald L. And Johnson, Eric J. 1996. “A Comparison of Two Process Tracing Methods for Choice Tasks.” Organizational Behavior and Human Decision Processes 68 (1) 28-43.

Procedural approaches are criticized for imprecisely uncovering the strategy used and providing overly broad insight about the respondents' process, e.g., classifying the decision as compensatory or non-compensatory or as attribute- or alternative-wise. Ford, Kevin J., Schmitt, Neal, Schechtmann, Susan L., Hults, Brian M., and Doherty, Mary L.

1989. “Process tracing methods: Contributions, problems and neglected research questions.”

Organizational Behavior and Human Decision Processes 43 75-117. Ball, Christofer. 1997.

“A Comparison of Single-Step and Multiple-Step Transition Analyses of Multiattribute Decision Strategies.” Organizational Behavior and Human Decision Processes 69 (3) 195-204. Yet, many different decision strategies that lead to a different final choice could fit into each of these classes. For this reason, the predictive power of procedural approaches is questionable.

Structural approaches use formal definitions of mathematical models that represent the relation between the alternative values and the final choice. These approaches often search for a single, parsimonious choice model that maximizes the likelihood of predicting the final respondent choice correctly. Harte, Joanna M. and Koehle, Pieter. 2001. “Modeling and Describing Human Judgement Processes: The Multiattribute Evaluation Case.” Thinking and Reasoning 7(1) 29-49. However, in cases when multiple choice models are estimated and compared (e.g., Gilbride Timothy J. and Allenby M. Greg. 2004. “A Choice Model with Conjunctive, Disjunctive, and Compensatory Screening Rules.” Marketing Science 23(3) 391-406., Gilbride Timothy J. and Allenby M. Greg. 2006. “Estimating Heterogeneous EBA and Economic Screening Rule Choice Models” Marketing Science 25(5) 494-509) structural approaches almost never identify the level of overlap between them. Moreover, structural approaches rarely investigate whether certain choice models have better predictive power under different task environments. This is a gap addressed by the experiments that are developed and applied in this embodiment.

The difficulty of estimating a heterogeneous decision model and analyzing the effects of the choice environment in a structural manner comes from the researchers' lack of knowledge about the respondent pre-experiment. Having no prior insight into the respondents' attribute values and other data necessary to model the choice process, researchers create alternatives that the respondent may reach using any of the assumed choice models. To address this problem, a two-step experiment is created in which, first, respondent utility finctions and attribute weights are derived through a conjoint analysis, and, second, an optimizer is used to create alternative sets per respondent so that each assumed decision strategy leads to a different alternative shown. By systematically varying the task environment, insight is provided into the adaptive decision process of each respondent, while still using a structural approach. The next section describes the design of the choice experiment of this embodiment in detail.

The design of the experiment has four stages: First, it is decided to test a number of decision-making strategies that do not exceed the least amount of alternatives shown in the experiment. Second, hypotheses are posited regarding the influence of task environments' variables on the decision-strategies used. Third, a conjoint analysis and a short survey are used to derive the respondent data needed to estimate the expected respondent choice. Fourth, a Genetic Algorithm (GA) is used to optimize alternative sets in which alternatives map one-to-one with the assumed decision strategies and to control for the task environment variables.

The approach makes three main assumptions: i) the data gathered in the conjoint analysis and the survey is a good representation of respondents' true internal states, ii) these internal states did not change before respondents' participated in the choice experiment (there was a ten-day lag), and iii) the four strategies tested cover as best as possible respondents' decision-making behavior when presented with alternatives in an environment similar to the experimental setting.

Four strategies are tested in this approach. WAD is the classic utility maximizing strategy in which the decision maker chooses the alternative with the highest alternative utility, defined as the sum of the weighted attribute utilities. More formally, each respondent needs to make a choice between alternatives i=1, . . . , K which are defined by a set of common attributes S. Each alternative has a utility score Uᵢ:

$${U}_{i} = {\sum }_{a ∈ S} {r}_{a} {V}_{a} ( {x}_{a , i} ) \qquad ( 1 )$$

where rₐ is respondent's attribute weight of attribute a; Vₐ(x_{a,i}) is the attribute utility of attribute a, x_{a,i} is the attribute value a for alternative i.

EQW is a version of WAD, differing only to the extent that the decision maker ignores attribute weights. The calculation of the LEX utility takes the following form:

$${U}_{i} = {\sum }_{a ∈ S} {V}_{a} ( {x}_{a , i} ) \qquad ( 2 )$$

WAD and EQW are utility maximization strategies. To derive the expected respondent choice the following maximization rule is followed:

i_{MAX}={i:U(i)≧f(j)∀ⱼ=1, . . . K} (3)

LEX and EBA are heuristics and are not represented as utility functions. LEX chooses the alternative with the highest attribute value on the most important attribute. If there is a tie between alternatives, they are compared on the rest of the attributes sorted in decreasing order of importance until one alternative remains or no more attributes remain to iterate.

EBA is a strategy in which the decision-maker selects attributes with a probability proportional to their importance (attribute weight) and all alternatives that have unacceptable attribute values are eliminated. The process continues until only one alternative remains. To simplify the decision-strategy, a deterministic variation of EBA is used that iterates through the attributes in decreasing order of their importance. The current approach could be extended with the probabilistic version of EBA (or any other decision strategy) in which a Markov chain Monte Carlo method would estimate the expected choice.

As WAD and EQW both rely on computation of utility values for all alternatives and attributes, whereas LEX and EBA narrow down the choice set presented, the former require a greater memory and computational effort than the latter. This distinction between the two pairs plays a central role in the hypotheses explored below.

Existing research of adaptive decision making suggests that task complexity can affect the strategy used. Four variables are focused upon: the number of alternatives available, the number of attributes on each alternative, the difficulty associated with identifying the utility maximizing choice, and, finally, the difficulty in identifying the best alternative along the most important attribute. All four variables increase the complexity of the decision-making environment. The more alternatives and attributes there are, the closer the choices are in terms of utility, and the closer the attribute values of the most important attribute are, the less respondents use a more computationally intensive strategy like WAD and EQW and the more they use simplifying strategies like LEX and EBA.

The number of alternatives and number of attributes has long been expected to influence the decision-making process. The first two hypotheses are formulated as:

HYPOTHESIS 1 (H1). An increase in the number of alternatives leads to a decrease in the use of WAD/EQW strategies and an increase in the use of LEX/EBA.

HYPOTHESIS 2 (H2). An increase in the number of attributes leads to a decrease in the use of WAD/EQW and an increase in the use of LEX/EBA.

An additional variable is introduced to measure task complexity: difficulty of identifying the utility maximizing choice (WAD difficulty, d_{WAD}):

d_{WAD}=1−w₁(U_{best}−U_{second})+w₂(U_{best}−U_{worst}) (4)

where U_{best}, U_{second} and U_{worst} are the best, second best, and worst alternatives in terms of their utilities. w₁ is set to 0.75 and w₂ to 0.25 to reflect higher weight on the distance between the best and second best alternatives than the distance between the best and worst alternatives.

HYPOTHESIS 3 (H3). An increase in WAD difficulty leads to a decrease in WAD/EQW and an increase in LEX/EBA.

Similarly, an alternative set can demand greater cognitive effort by increasing the difficulty of identifying the best alternative along the most important attribute (LEX difficulty, d_{LEX}):

d_{LEX}=1−w₁(V_{best}−V_{second})+w₂(V_{best}−V_{worst}) (5)

where V_{best}, V_{second} and V_{worst} are the attribute values of the first, second, and last alternative in terms of attribute weight. Again, w₁ is set to 0.75 and w₂ to 0.25.

HYPOTHESIS 4 (H4). An increase in LEX difficulty leads to a decrease in LEX and EBA and an increase in WAD and EQW.

Each of the four independent variables, the number of attributes, the number of alternatives, the WAD difficulty, and the LEX difficulty, have two levels. 4 and 7 alternatives and attributes are considered, and WAD and LEX difficulty can be low or high. This yields a 4×2 experimental design with 16 different possible combinations of the independent variables (Table 10). Each experiment generated by the optimization algorithm presents all 16 alternative sets to each respondent in random order.

Finally, informed by recent research, which finds that strategy variability is inherent in consumer choice, whether respondents actually show consistency in the strategies they use, even in the face of changing alternative sets, is examined.

HYPOTHESIS 5 (H5). Respondents use one strategy with a greater frequency than others.

TABLE 10
The 16 experimental combinations. They are shown in random
order to respondents.

| | | Low WAD | | | |
|---|---|---|---|---|---|
| | | difficulty | | High WAD | |
| | | | High | difficulty | |
| | | Low LEX | LEX | Low LEX | High LEX |
| 4 alternatives | 4 attributes | Alt. Set 1 | 5 | 9 | 13 |
| | 7 attributes | 2 | 6 | 10 | 14 |
| 7 alternatives | 4 attributes | 3 | 7 | 11 | 15 |
| | 7 attributes | 4 | 8 | 12 | 16 |

To estimate the expected choice data is needed about each respondents' utility function (for WAD, EQW, and LEX), attribute weights (for WAD, LEX, and EBA), and aspiration levels (for EBA). The utilities and attribute weights were obtained in an adaptive conjoint analysis (ACA) for fifteen attributes that define cell phones for 594 respondents. Respondents self-reported aspiration levels for all attributes were also recorded by asking which attribute values they find unacceptable. Table 11 shows all attributes and attribute values tested.

TABLE 11
Attributes and their values used in the experiment

| Attribute | Attribute Value |
|---|---|
| Sales Ranking | #1 |
| | #3 |
| | #5 |
| | #10 |
| | #20 |
| Weight | 100 g |
| | 105 g |
| | 110 g |
| | 115 g |
| | 120 g |
| Resolution | 5 mega pixel |
| | 4 mega pixel |
| | 3 mega pixel |
| | 2 mega pixel |
| | 1 mega pixel |
| Display | 3.2 |
| | 3 |
| | 2.8 |
| | 2.7 |
| | 2.5 |
| Manufacturer | Brand A |
| | Brand B |
| | Brand C |
| | Brand D |
| | Brand E |
| Form | Fold |
| | Slide |
| | Straight |
| Thickness | 10 mm |
| | 15 mm |
| | 20 mm |
| Zoom | 3x |
| | 2x |
| | No Zoom |
| Memory Capacity | 100 MB |
| | 50 MB |
| | 25 MB |
| Battery Duration | 700 min |
| | 600 min |
| | 500 min |
| TV | With |
| | W/out |
| Image Stabilizer | With |
| | W/out |
| e-Wallet | With |
| | W/out |
| GPS Function | With |
| | W/out |
| Bluetooth | With |
| | W/out |

Attributes are separated into three groups depending on the possible number of attribute values (5, 3, and 2), which helps control the amount of information presented to each respondent in the experiment.

The experiment presented here controls for the four variables discussed above and maps four decision-making strategies to different alternatives from the choice set. The design of the experiment has three objectives and four constraints. The objectives demand an optimization technique due to the large number of solutions. For example, in an experiment with seven alternatives defined by seven attributes, each taking three allowed values, the number of possible alternative sets is 3.8*10¹².

OBJECTIVE 1. Create choice tasks with a one-to-one mapping between alternatives and strategies.

OBJECTIVE 2. Create choice tasks that are difficult/easy according to the maximization of utility (low or high WAD difficulty, to test H3).

OBJECTIVE 3. Create choice tasks that are difficult/easy for respondents identifying the highest utility for the most important attribute (low or high LEX difficulty, to test H4).

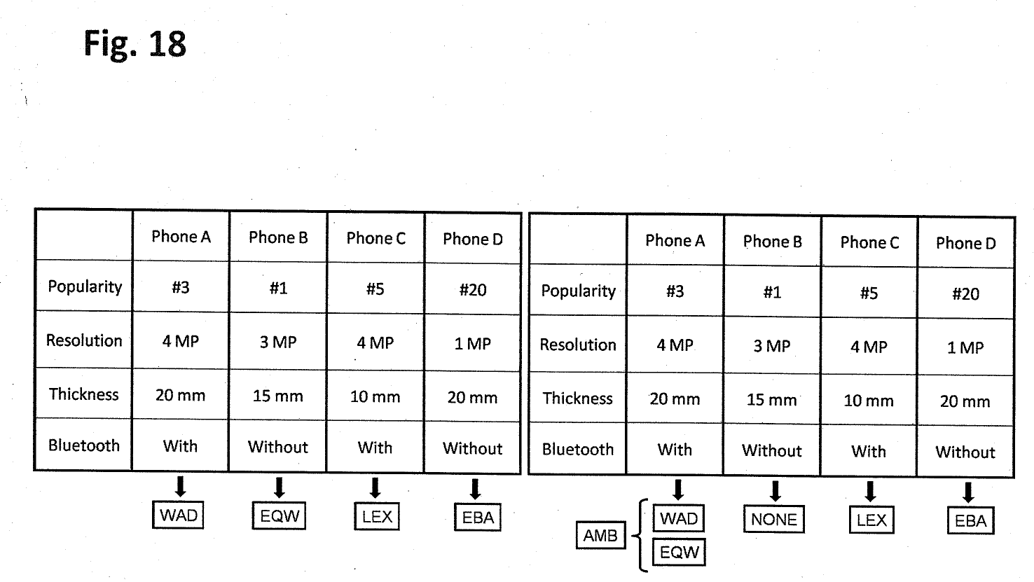

The first objective is a crucial factor in the ability to speculate about the decision-making strategies used by different respondents. Mapping the strategies to the choices uncovers which strategies the respondent did not use, and acknowledges the possibility that one of the remaining strategies was used. FIG. 18 shows a typical choice set produced by the optimization algorithm. The left choice set demonstrates a perfect one-to-one mapping, while the right shows a non-perfect one-to-one mapping. Here, choosing phone A is ambiguous (labeled “AMB”) because more than one strategy explains that choice. Also, no strategy explains the choice of phone B (labeled “NONE”). Objective 1 minimizes ambiguous and NONE-mappings.

In addition to the three objectives, the design of the choice experiment has four constraints that control for two additional variables and two factors that may influence the respondent decision-making process.

CONSTRAINT 1. Create alternative sets with a pre-set number of alternatives presented (4 and 7, to test H1).

CONSTRAINT 2. Create alternatives with a pre-set number of attributes presented (4 and 7, to test H2).

CONSTRAINT 3. Create alternative sets with equal complexity of information presented for alternative sets that test the same independent variables.

Two alternative sets with the same number of alternatives and attributes and same levels of WAD and LEX difficulty are going to have different task complexity if one shows attributes that take two attribute values (e.g., with or without GPS function) and the other with attributes that take five attribute values (e.g., five levels of screen resolution). To control for the amount of information shown in each alternative set, the same amount of attribute levels always are shown.

CONSTRAINT 4. Always show the minimum and maximum attribute values for all attributes.

Attribute weights of additive utility functions are dependent on the maximum and minimum values shown per attribute. To avoid cognitive biases caused by this effect, the choice tasks always include the lowest and highest part-worth of each respondent.

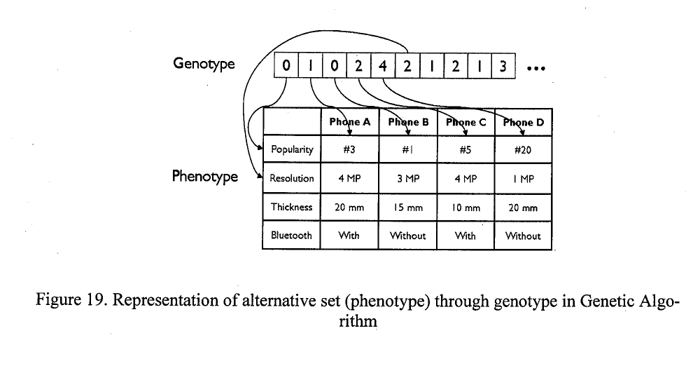

A Genetic Algorithm (GA), a search and optimization technique inspired by evoiutionary biology, is used to design the alternative sets presented to each respondent. A GA is applicable to this optimization problem because the search space is not well defined beforehand. The GA requires an abstract representation (a genotype) of the candidate solutions (phenotypes). In this case, the genotype represents alternative sets as sequences of bits of information (genes), which can be of two types: attribute group genes and attribute level genes. The attribute group genes determine which attributes are included in a particular alternative set. The value of the attribute group gene is the index of a sorted list of attributes by attribute weight. Each attribute group gene is followed by as many attribute level genes as there are alternatives shown. The attribute level determines the value the attribute is going to take for the particular alternative. The value of the attribute level is the index of a list of attribute values sorted in decreasing order. For example, the gene at the first position in FIG. 19 means that the most important attribute (popularity) for the example respondent is included in the description of alternatives. The gene at the second position means that the first alternative will have the sales rank with the second highest utility for that particular respondent (in this case, sales rank of #3).

A fitness function evaluates each alternative set in terms of how well it satisfies the experimental objectives, i.e., each alternative set's performance on WAD difficulty (d₁), LEX difficulty (d₂), and the mapping fitness (m). The formulas for calculating WAD and LEX difficulty were provided in Equation 1 and 2 above. The mapping fitness measures how many decision-making strategies unambiguously map to unique alternatives in each alternative set. For example, the set on the left in FIG. 18 has one-to-one alternative to strategy mappings for all four alternatives (m=4), but the set on the right has only two unique mappings (m=2).

TABLE 12
Fitness calculations for different independent variables.

| Alt. Set | WAD difficulty | LEX difficulty | Fitness |
|---|---|---|---|
| 1-4 | low | low | F = m − d₁ − d₂ |
| 5-8 | high | low | F = m + d₁ − d₂ |
| 9-13 | low | high | F = m − d₁ + d₂ |
| 13-16 | high | high | F = m + d₁ + d₂ |

The four related formulas shown in Table 12 determine the fitness of each alternative set depending on the level of WAD and LEX difficulties being tested. The better the choice sets serve the objectives, the better the fitness value is. Given that d₁ε[0,1], d₂ε[0,1] and mε[0,4], F̅_̅{̅M̅A̅X̅}̅=5.0.

Starting with a group of randomly-generated alternative sets, the GA recombines pieces of existing alternative sets (crossover), makes random changes (mutation), and imposes the constraints (repair) to create alternative sets that are increasingly closer to the optimal solution. The parameters needed to replicate the GA are as follows: For recombination a mixture of uniform and one-point crossover with crossover probability of 100% is used. For mutation 1 is added or subtracted to each gene with p=2/l where p is the mutation probability and l is the genome length. For selection a standard tournament crossover is used with size 2. The algorithm is run for 800 generations of size 125 with an elitist method.

The genetic algorithm created 9504 alternative sets for 594 respondents. In addition to satisfying the constraints of the experimental design, the GA created 8510 (89.54%) sets with perfect one-to-one mapping of alternatives to decision strategies, 478 sets (5.02%) that mapped two alternatives to decision-strategies unambiguously, 238 sets (2.52%) that mapped only one alternative to a strategy unambiguously, and 278 sets (2.92%) that had no unique mappings. Taking into account the full fitness function that includes the three objectives, the average fitness for all alternative sets created for all respondents was 3.7, or 74% of the theoretical F̅_̅{̅M̅A̅X̅}̅.

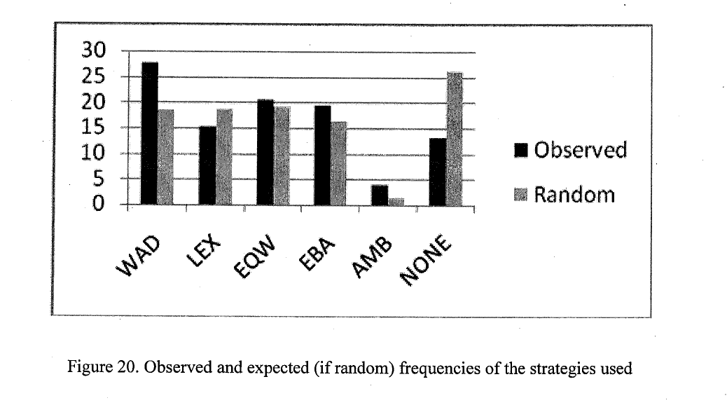

Respondent choices indicate usage of different decision strategies. Alternatives selected most often mapped to WAD (27.73%), followed by EQW (20.53%), EBA (19.37%), and LEX (15.28%). In 3.96% of cases the respondent choice mapped to more than one strategy (AMB) and in 13.13% of cases the respondent choice did not map to any strategy tested (NONE) (See “observed” bars in FIG. 20).

To explore the statistical significance of strategy frequencies and the correlation effects with task environment variables, the observed frequencies are compared to a baseline, which is the probability of a strategy mapping to a chosen alternative if the respondents had been randomly making choices. Given that the GA generated some alternative sets that matched more than one strategy to one alternative, the expected random probabilities for the four strategies are not equal and are computed. The expected random probabilities are 18.54% (WAD), 18.6 (LEX), 19.13 (EQW), 16.33% (EBA), 1.35% (AMB), and 26.05% (NONE) (See “random” bars in FIG. 20).

The results show that chosen alternatives mapped to no strategy (NONE) half as often as expected, suggesting that the respondents were using the strategies of the experiment. The chosen alternatives mapped to WAD 50% more often than expected, to EBA 19% and to EQW 7%. Choices mapped to LEX 18% less frequently then it would be expected under random choice, lending little evidence for the usage of this strategy.

A Chi-square test was used to determine the Cramer's V association value between the five variables that define hypotheses and the strategies used. The WAD difficulty and respondent ID have a significant effect on the strategy used with Cramer's V of 0.4 and 0.45, respectively (See Table 13). The high association between the respondent ID and strategy points to a large degree of respondent consistency in using one strategy most of the time. The number of alternatives receives a high value, mostly due to the increase in NONE when seven alternatives are presented. The number of attributes has a small effect and LEX difficulty has no significant effect. The next four sections discuss in detail each of the hypotheses tested.

TABLE 13
Strength of Hypotheses.

| Hypothesis | Cramer's V |
|---|---|
| H1. Number of alternatives | 0.35 |
| H2. Number of attributes | 0.09 |
| H3. WAD difficulty | 0.40 |
| H4. LEX difficulty | 0.00 |
| H5. Respondent ID | 0.45 |

Statistically significant results at 0.01 level are in bold.

(In the remaining part of this discussion the correlations are shown only if they are significant at level 0.01. Coefficients greater than 0.2 in scale problems and greater than 0.1 in nominal and ordinal problems indicate non-weak correlation and are typed in bold.)

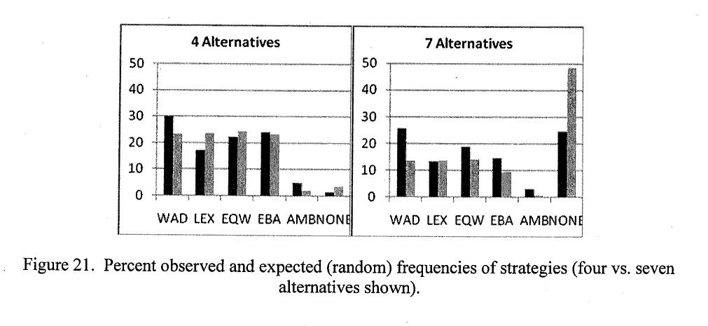

FIG. 21 shows the observed (darker bars) and baseline random frequencies of strategies (lighter bars) used in alternative sets with four and seven alternatives (left and right in figure).

Table 14 summarizes the results for the effects of number of alternatives on decision strategy. The values given for four and seven alternatives show the ratio between the observed strategies and the expected random frequency. The percentages in the brackets are the actual frequencies observed. All correlations shown in this section are significant at the 0.01 level (double tailed).

TABLE 14
Summary of results regarding number of alternatives.

| | | | Correlation |
|---|---|---|---|
| | Four alternatives | Seven alternatives | (Kendall tau-b) |
| WAD | 1.28 (30%) | 1.87 (25%) | −0.05 |
| LEX | 0.73 (17%) | 0.97 (13%) | −0.06 |
| EQW | 0.92 (22%) | 1.34 (19%) | −0.04 |
| EBA | 1.03 (24%) | 1.56 (15%) | −0.12 |
| AMB | 2.50 (5%) | 4.08 (3%) | −0.05 |
| NONE | 0.43 (2%) | 0.51 (24%) | 0.34 |

The strongest effect is measured regarding the choices that map to no strategy, which indicates that when presented with a large number of alternatives the respondents increasingly deviate from the assumed decision-strategies. The other strong effect is the decrease in the usage of EBA when the number of alternatives rises. This diminished usage of a heuristic in light of increased complexity is contrary evidence for H1.

The effect of the number of attributes on decision strategy is significant but weak (V-Cramer=0.1). A larger number of attributes is positively associated with the WAD strategy and negatively with EBA and AMB. The number of attributes had no significant effect on LEX, EQW, and NONE. In general, the number of attributes had the lowest impact on the frequencies of observed decision strategies, lending no evidence for H2.

TABLE 15
Summary of results regarding number of attributes.

| | | | Correlation |
|---|---|---|---|
| | Four attributes | Seven attributes | (Kendall tau-b) |
| WAD | 1.39 (25%) | 1.60 (30%) | 0.061 |
| LEX | 0.79 (14%) | 0.85 (16%) | |
| EQW | 1.11 (21%) | 1.04 (20%) | |
| EBA | 1.29 (20%) | 1.09 (18%) | −027 |
| AMB | 2.80 (5%) | 3.22 (3%) | −0.058 |
| NONE | 0.52 (14%) | 0.49 (12%) | |

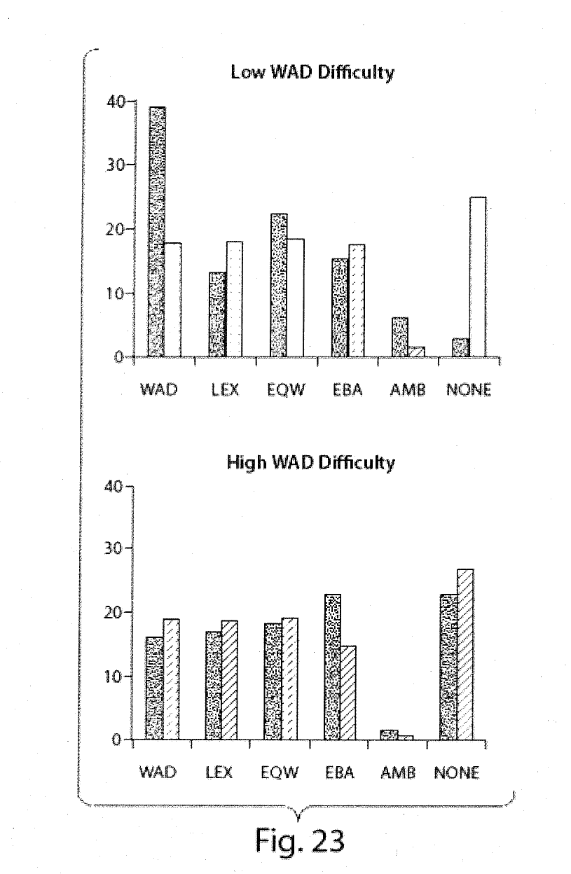

Of the four independent variables, WAD difficulty has the highest effect on the observed decision strategy. The increase in WAD difficulty leads to diminished frequency of WAD and vice-versa. Respondent choices map to WAD more than twice as often then expected when WAD difficulty is low and 15% less than expected when WAD difficulty is high (FIG. 23). Furthermore, 70% of all WAD mappings occurred in low WAD difficulty and 30% in high WAD difficulty.

Similarly to the test of H1, NONE mappings significantly increase with increased task difficulty, which points to the possibility that deviations from the assumed strategies are more numerous in cases when WAD difficulty is high.

The increase in EBA in alternative sets that have high WAD difficulty is a non-weak effect, which in conjunction to the decrease in WAD, yields positive evidence for H3.

TABLE 16
Summary of results regarding WAD difficulty

| | | | Correlation |
|---|---|---|---|
| | Low WAD difficulty | High WAD difficulty | (Kendall tau-b) |
| WAD | 2.17 (39%) | 0.85 (16%) | −0.26 |
| LEX | 0.73 (13%) | 0.91 (17%) | 0.05 |
| EQW | 1.20 (23%) | 0.95 (18%) | −0.05 |
| EBA | 0.87 (16%) | 1.56 (23%) | 0.10 |
| AMB | 3.38 (6%) | 2.00 (2%) | −0.11 |
| NONE | 0.12 (3%) | 0.86 (23%) | 0.30 |

LEX difficulty has no significant effect on the strategy used. The correlation coefficients between the observed and expected mappings between alternatives and strategies show low statistical significance of this variable (Table 17).

TABLE 17
Summary of results regarding Lex difficulty.

| | | | Correlation |
|---|---|---|---|
| | Low LEX difficulty | High LEX difficulty | (Kendall tau-b) |
| WAD | 1.50 (28%) | 1.49 (28%) | |
| LEX | 0.77 (14%) | 0.87 (16%) | 0.027 |
| EQW | 1.06 (20%) | 1.09 (21%) | |
| EBA | 1.22 (20%) | 1.16 (19%) | |
| AMB | 2.91 (4%) | 2.96 (4%) | |
| NONE | 0.53 (14%) | 0.48 (12%) | |

Respondents were clustered using a K-Means algorithm into six groups according to the strategy they used most often. In addition to the four strategies and the AMB choice a MIX cluster is created for respondents who alternate between WAD and EBA. The data fits well and makes informative clusters.

Table 18 shows the average number of strategies used by each cluster. For instance, the respondents that fit into the WAD cluster chose the alternative that mapped to the EBA strategy 7.76 times on average out of the 16 alternative sets. The distribution of respondents in clusters is not uniform. The WAD cluster is the largest with 168 respondents. The AMB cluster is the smallest cluster with 28 respondents.

TABLE 18
Summary of the cluster analysis.

| | WAD | LEX | EQW | EBA | AMB | MIX |
|---|---|---|---|---|---|---|
| | cluster | cluster | cluster | cluster | cluster | cluster |
| Percent of | 48.5 | 46.9 | 46.3 | 56.2 | 53.8 | 25.7 |
| choices | | | | | | (EBA), |
| | | | | | | 23.5 |
| | | | | | | (WAD) |
| WAD mean | 7.76 | 2.95 | 3.16 | 2.52 | 1.50 | 3.77 |
| LEX mean | 2.15 | 7.49 | 1.42 | 0.73 | 1.43 | 1.85 |
| EQW mean | 2.14 | 2.36 | 7.42 | 1.43 | 1.00 | 3.13 |
| EBA mean | 2.00 | 1.43 | 2.04 | 9.00 | 0.04 | 4.11 |
| AMB mean | 0.23 | 0.35 | 0.25 | 0.13 | 8.61 | 0.23 |
| NONE mean | 1.72 | 1.42 | 1.72 | 2.19 | 3.43 | 2.91 |
| Cluster size | 168 | 77 | 113 | 63 | 28 | 145 |

Table 18 shows that respondents, who have been classified in a cluster, chose the given dominant strategy in about 50% of cases. The contingency coefficient between cluster membership and strategy chosen is 0.64, which indicates a strong association between the two variables and corroborates H5.

In summary, the general methodology disclosed herein is flexible enough to be applied to a wide variety of decision-making behavior. The genetic algorithm can be applied to any search space defined in terms of its constraints, the independent variables, and the decision-making behavior of interest. The GA designs choice experiments which uncover the strategies used either through a statistical analysis or an implementation of machine learning techniques. The final goal of the application of the methodology on a wide variety of choice settings is the creation of a library of human decision-making heuristics and biases and an understanding of the rules that govern them.

Any of the above aspects of the methods disclosed, and their application in systems, may include one or more of the following features. The memory storage device may be selected from a group comprising: a semiconductor memory device, a flash memory device, a magnetic disk, an internal hard disk, a removable disk, a magneto-optical disk, a CDROM disk and a DVD-ROM disk. Other memory devices known to persons of skill in the art also are contemplated.

In other implementations, the evolutionary algorithm may include at least one of the following genetic operators: a selection operator, a mutation operator, a recombination operator, a crossover operator, a directed operator, a constraint operator, or a preservation operator.

Other implementations are directed to the evolutionary algorithm including a crossover operator configured to combine genes of two given genetic strings to produce an offspring.

As used herein, a “user interface” is an interface between a human user and a computer that enables communication between the user and the computer. A user interface may include an auditory indicator such as a speaker, and/or a graphical user interface (GUI) including one or more displays. A user interface also may include one or more selection devices including a mouse, a keyboard, a keypad, a track ball, a microphone, a touch screen, a game controller (e.g., a joystick), etc., or any combinations thereof.

As used herein, an “application programming interface” or “API” is a set of one or more computer-readable instructions that provide access to one or more other sets of computer-readable instructions that define functions, so that such functions can be configured to be executed on a computer in conjunction with an application program, in some instances to communicate various data, parameters, and general information between two programs.

The various methods, acts thereof, and various embodiments and variations of these methods and acts, individually or in combination, may be defined by computer-readable signals tangibly embodied on one or more computer-readable media, for example, non-volatile recording media, integrated circuit memory elements, or a combination thereof. Such signals may define instructions, for example, as part of one or more programs that, as a result of being executed by a computer, instruct the computer to perform one or more of the methods or acts described herein, and/or various embodiments, variations and combination thereof. Such instructions may be written in any of a plurality of programming languages or using any of a plurality of programming techniques.

For example, various methods according to the present disclosure may be programmed using an object-oriented programming language. Alternatively, functional, scripting, and/or logical programming languages may be used. Various aspects of the disclosure may be implemented in a non-programmed environment (e.g., documents created in HTML, XML or other format that, when viewed in a window of a browser program, render aspects of a graphical-user interface (GUI) or perform other functions). Various aspects of the disclosure may be implemented as programmed or non-programmed elements, or combinations thereof.

A given computer-readable medium may be transportable such that the instructions stored thereon can be loaded onto any computer system resource to implement various aspects of the present disclosure. In addition, it should be appreciated that the instructions stored on the computer-readable medium are not limited to instructions embodied as part of an application program running on a host computer. Rather, the instructions may be embodied as any type of computer code (e.g., software or microcode) that can be employed to program a processor to implement various aspects of the present disclosure.

Having thus described several illustrative embodiments, it is to be appreciated that various alterations, modifications, and improvements will readily occur to those skilled in the art. Such alterations, modifications, and improvements are intended to be part of this disclosure, and are intended to be within the spirit and scope of this disclosure. While some examples presented herein involve specific combinations of functions or structural elements, it should be understood that those functions and elements may be combined in other ways according to the present disclosure to accomplish the same or different objectives. In particular, acts, elements, and features discussed in connection with one embodiment are not intended to be excluded from similar or other roles in other embodiments. Accordingly, the foregoing description and attached drawings are by way of example only, and are not intended to be limiting.

1. In a computer system comprising at least one input device, at least one output device, and at least one processor, a method of generating and using a set of choice experiments, comprising:
a. for each of a plurality of respondents, for a preselected product, for a predetermined number of product attributes, determining at least some of the said respondent's product attribute weights and product attribute utilities;
b. for each of the plurality of respondents, based upon the determined product attribute weights and product attribute utilities, creating by means of a processor using a genetic algorithm a set of choice experiments;
c. for each of the plurality of respondents, for each of a plurality of the set of created choice experiments associated with the said respondent, displaying by means of an output device the said choice experiment;
d. for each of the plurality of respondents, for each of the plurality of the set of created choice experiments displayed, receiving by means of an input device a response to the choice experiment displayed;
e. analyzing at least a plurality of the received responses to the choice experiments; and
f. outputting by means of an output device at least one result of the analysis of the received responses.

2. The method of claim 1, wherein at least one of the choice experiments created comprises a comparison matrix presenting a predetermined number of product alternatives, each characterized by a predetermined number of product attributes.

3. The method of claim 1, wherein a purpose of the choice experiments is to analyze respondent decision strategies.

4. The method of claim 1, wherein determining at least some of the said respondent's product attribute weights and product attribute utilities comprises use of adaptive conjoint analysis.

5. The method of claim 1, wherein each of a plurality of the sets of choice experiments created comprises a choice-based conjoint analysis.

6. The method of claim 1, wherein creating a choice experiment comprises determining a number of product alternatives to be presented, determining a number of product attributes to be presented for each product alternative presented, choosing product alternatives to be presented, and choosing product attributes to be presented.

7. The method of claim 1, wherein creating a set of choice experiments is based upon a preselected plurality of decision making strategies to be analyzed and an objective of the genetic algorithm is to create choice experiments in which each choice maps to one and only one of the preselected plurality of decision making strategies to be analyzed.

8. The method of claim 1, wherein each genotype analyzed by the genetic algorithm comprises attribute level genes and attribute group genes.

9. The method of claim 1, wherein analyzing at least a plurality of the received responses to the choice experiments comprises use of statistical analysis and machine learning techniques.

10. The method of claim 1, wherein operation of the genetic algorithm includes one of more of: a mutation operator and a crossover operator.

11. A computer readable medium, containing instructions which, when executed in a computer system comprising at least one input device, at least one output device, and at least one processor, cause the said computer system to perform a method of generating and using a set of choice experiments, comprising:
a. for each of a plurality of respondents, for a preselected product, for a predetermined number of product attributes, determining at least some of the said respondent's product attribute weights and product attribute utilities;
b. for each of the plurality of respondents, based upon the determined product attribute weights and product attribute utilities, creating by means of a processor using a genetic algorithm a set of choice experiments;
c. for each of the plurality of respondents, for each of a plurality of the set of created choice experiments associated with the said respondent, displaying by means of an output device the said choice experiment;
d. for each of the plurality of respondents, for each of the plurality of the set of created choice experiments displayed, receiving by means of an input device a response to the choice experiment displayed;
e. analyzing at least a plurality of the received responses to the choice experiments; and
f. outputting by means of an output device at least one result of the analysis of the received responses.

12. The computer readable medium of claim 11, wherein at least one of the choice experiments created comprises a comparison matrix presenting a predetermined number of product alternatives, each characterized by a predetermined number of product attributes.

13. The computer readable medium of claim 11, wherein a purpose of the choice experiments is to analyze respondent decision strategies.

14. The computer readable medium of claim 11, wherein determining at least some of the said respondent's product attribute weights and product attribute utilities comprises use of adaptive conjoint analysis.

15. The computer readable medium of claim 11, wherein each of a plurality of the sets of choice experiments created comprises a choice-based conjoint analysis.

16. The computer readable medium of claim 11, wherein creating a choice experiment comprises determining a number of product alternatives to be presented, determining a number of product attributes to be presented for each product alternative presented, choosing product alternatives to be presented, and choosing product attributes to be presented.

17. The computer readable medium of claim 11, wherein creating a set of choice experiments is based upon a preselected plurality of decision making strategies to be analyzed and an objective of the genetic algorithm is to create choice experiments in which each choice maps to one and only one of the preselected plurality of decision making strategies to be analyzed.

18. The computer readable medium of claim 11, wherein each genotype analyzed by the genetic algorithm comprises attribute level genes and attribute group genes.

19. The computer readable medium of claim 11, wherein analyzing at least a plurality of the received responses to the choice experiments comprises use of statistical analysis and machine learning techniques.

20. The computer readable medium of claim 11, wherein operation of the genetic algorithm includes one of more of: a mutation operator and a crossover operator.

21. A computer system, comprising at least one input device, at least one output device, and at least one processor, configured to perform a method of generating and using a set of choice experiments, comprising:
a. for each of a plurality of respondents, for a preselected product, for a predetermined number of product attributes, determining at least some of the said respondent's product attribute weights and product attribute utilities;
b. for each of the plurality of respondents, based upon the determined product attribute weights and product attribute utilities, creating by means of a processor using a genetic algorithm a set of choice experiments;
c. for each of the plurality of respondents, for each of a plurality of the set of created choice experiments associated with the said respondent, displaying by means of an output device the said choice experiment;
d. for each of the plurality of respondents, for each of the plurality of the set of created choice experiments displayed, receiving by means of an input device a response to the choice experiment displayed;
e. analyzing at least a plurality of the received responses to the choice experiments; and
f. outputting by means of an output device at least one result of the analysis of the received responses.

22. The computer system of claim 21, wherein at least one of the choice experiments created comprises a comparison matrix presenting a predetermined number of product alternatives, each characterized by a predetermined number of product attributes.

23. The computer system of claim 21, wherein a purpose of the choice experiments is to analyze respondent decision strategies.

24. The computer system of claim 21, wherein determining at least some of the said respondent's product attribute weights and product attribute utilities comprises use of adaptive conjoint analysis.

25. The computer system of claim 21, wherein each of a plurality of the sets of choice experiments created comprises a choice-based conjoint analysis.

26. The computer system of claim 21, wherein creating a choice experiment comprises determining a number of product alternatives to be presented, determining a number of product attributes to be presented for each product alternative presented, choosing product alternatives to be presented, and choosing product attributes to be presented.

27. The computer system of claim 21, wherein creating a set of choice experiments is based upon a preselected plurality of decision making strategies to be analyzed and an objective of the genetic algorithm is to create choice experiments in which each choice maps to one and only one of the preselected plurality of decision making strategies to be analyzed.

28. The computer system of claim 21, wherein each genotype analyzed by the genetic algorithm comprises attribute level genes and attribute group genes.

29. The computer system of claim 21, wherein analyzing at least a plurality of the received responses to the choice experiments comprises use of statistical analysis and machine learning techniques.

30. The computer system of claim 21, wherein operation of the genetic algorithm includes one of more of: a mutation operator and a crossover operator.
